(19) United States
(12) Patent Application Publication
(10) Pub. No.: US 2025/0304469 A1
(43) Pub. Date: Oct. 2, 2025

(54) Disinfection Using Synergistic Effects of Visible Light and Chemicals

(71) Applicant: Vyv, Inc., Latham, NY (US)

(72) Inventors: Cori Joslyn Winslow, Troy, NY (US); Steven John Fikes, Schenectady, NY (US)

(21) Appl. No.: 19/092,258

(22) Filed: Mar. 27, 2025

Related U.S. Application Data
(60) Provisional application No. 63/570,295, filed on Mar. 27, 2024.

(51) Int. Cl. C02F 1/32; C02F 1/00; C02F 1/50

(52) U.S. Cl. CPC C02F 1/325; C02F 1/008; C02F 1/50; C02F 2201/322; C02F 2209/001; C02F 2303/04

(57) ABSTRACT

A method and device for disinfecting a body of water including the steps of detecting a microbial characteristic of a body of water via a sensor and comparing the microbial characteristic to a target threshold. Upon determining the microbial characteristic is below the target threshold, the method further includes the steps of emitting, via a light emitter in a device, a disinfecting light comprising a wavelength range of 380-420 nanometers (nm) into the body of water, determining, via a controller, a concentration and frequency of chemicals to deposit into the body of water based on the detected microbial characteristic, and depositing, via a mechanism in a device, a chemical into the body of water at the determined concentration and frequency.

### CROSS REFERENCE TO RELATED APPLICATIONS

This application claims benefit to U.S. Provisional Application No. 63/570,295, filed Mar. 27, 2024, entitled “Disinfection Using Synergistic Effects of Visible Light and Chemicals.” The above application is hereby incorporated herein by reference.

### TECHNICAL FIELD

Aspects of the present disclosure generally relate to processes, systems, devices, and apparatus for disinfection using visible light combined with chemicals.

### BACKGROUND

Bacterial and microorganism inactivation is a crucial practice required in many areas of both personal and environmental hygiene for the benefit of human health. Many methods may be employed for a variety of situations where human health factors may be improved by inactivating bacteria and microorganisms. Sickness and infection are the primary concerns of microorganism contamination through the many modes of intake of organisms into the human body from the environment, including from bodies of air or water. The human body may become sickened or infected by many different modes. Some modes may be due to internal imbalances of natural human microorganisms, but many problematic cases are caused by the transmission of microorganisms by either human to human contact or proximity, or by intake of microorganisms from the immediate environment, including breathing in contaminated air or being exposed to contaminated water.

Environments comprising water may be prone to microorganism growth that can be harmful to humans. Environments may include pools, hot tubs, spas, waste water systems, water treatment plants, and other bodies of water. Some microorganisms are more likely to thrive in such environments including but not limited to Escherichia coli, Staphylococcus aureus, Pseudomonas aeruginosa, and Legionella pneumophila. These pathogens can cause health concerns when exposed to humans such as gut, skin, urinary tract, and respiratory infections.

Methods exist today for the sanitization and disinfection of bodies of water through chemical usage. High chemical contents in bodies of water such as pools or hot tubs can cause health concerns for humans such irritation of the eyes, skin, hair, teeth, and respiratory system. Chemicals can additionally dry out skin, hair, and nails. In some cases, chlorine poisoning is possible as well as chemical burns. Chemicals can additionally be costly and the periodic requirement for them creates a burden on the caretaker of the pool or hot tub to continuously ensure that it is properly sanitized.

It would be desirable to eliminate or destroy harmful microorganisms contaminating the water-based environments that humans are exposed to for the benefit of human health. In particular, it would be advantageous to disinfect bodies of waters humans are exposed to such as hot tubs, spas, tanks, and pools. It would additionally be advantageous to provide disinfection in a way that reduces the amount of chemicals used for both human health and reducing the effort required to maintain sanitization or disinfection of a pool or hot tub.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure provide methods, devices, and techniques for disinfection using the synergistic effects of visible light and chemicals.

According to one aspect of the present disclosure, a method for disinfecting a body of water comprising detecting a microbial characteristic of a body of water via a sensor and comparing the microbial characteristic to a target threshold. Wherein upon determining the microbial characteristic is below the target threshold, the method further comprises outputting, via a light emitter in a device, a disinfecting light comprising a wavelength range of 380-420 nanometers (nm) into the body of water and depositing, via a mechanism in a device, a chemical into the body of water at a determined concentration and frequency.

According to one aspect of the present disclosure, a device for disinfecting a body of water comprising a housing configured to float at the surface of a body of water, wherein a portion of the housing is above the surface of the body of water and a portion of the housing is below the surface of the body of water, a light emitter disposed within the housing below the surface of the body of water and configured to emit light within the wavelength range of 380 to 420 nanometers (nm) at a determined radiometric power into the body of water, and a mechanism disposed within the housing below the surface of the body of water and configured to deposit chemicals at a determined concentration and frequency into the body of water.

The foregoing and other features of this disclosure will be apparent from the following description of examples of the disclosure.

### BRIEF DESCRIPTION OF THE DRAWINGS

The present disclosure is illustrated by way of example and not limited in the accompanying figures in which like reference numerals indicate similar elements and in which:

FIG. 1A illustrates an example device configured to emit disinfecting light and deposit chemicals into a body of water as disclosed herein.

FIG. 1B illustrates a cross sectional view of the example device of FIG. 1A.

FIG. 2 illustrates an example device configured to emit disinfecting light and deposit chemicals into a body of water as disclosed herein.

FIG. 3A illustrates an example device built into a surface and configured to emit disinfecting light and deposit chemicals into a body of water as disclosed herein.

FIG. 3B illustrates an example device built into a surface and configured to emit disinfecting light and deposit chemicals into a body of water as disclosed herein.

FIG. 4 illustrates a cross sectional view of an example device configured to emit disinfecting light and deposit chemicals into a body of water as disclosed herein.

FIG. 5 illustrates an example device configured to mount to a surface and configured to emit disinfecting light and deposit chemicals into a body of water as disclosed herein.

FIG. 6 illustrates an example device configured to emit disinfecting light and deposit chemicals into a body of water as disclosed herein.

FIG. 7 illustrates a cross sectional view of an example device configured to emit disinfecting light and deposit chemicals in the form of a liquid into a body of water as disclosed herein.

FIG. 8 illustrates an example device configured to control the deposition of chemical through features within the device as disclosed herein.

FIG. 9 illustrates an example device comprising one or more integrated sensors and at least one remote sensor and configured to emit disinfecting light and deposit chemicals into a body of water as disclosed herein.

FIG. 10 illustrates an example flow chart of example processes for using disinfecting light and chemicals to disinfect a body of water as disclosed herein.

FIG. 11 illustrates an example flow chart of example processes for using disinfecting light and chemicals to disinfect a body of water as disclosed herein.

FIG. 12A illustrates an example flow chart of example processes for using disinfecting light to disinfect a body of water as disclosed herein.

FIG. 12B illustrates an example flow chart of example processes for using chemicals to disinfect a body of water as disclosed herein.

FIG. 13 illustrates an example flow chart of example processes for using disinfecting light and chemicals to disinfect a body of water as disclosed herein.

FIG. 14 illustrates an example flow chart of example processes for using disinfecting light to disinfect a body of water as disclosed herein.

FIG. 15 illustrates an example flow chart of example processes for using disinfecting light and chemicals to disinfect a body of water as disclosed herein.

FIG. 16 illustrates an example flow chart of example processes for using disinfecting light and chemicals to disinfect a body of water as disclosed herein.

FIG. 17 illustrates an example device comprising thermal management features and configured to emit disinfecting light and deposit chemicals into a body of water as disclosed herein.

FIG. 18A illustrates an example device configured to emit disinfecting light into a body of water as disclosed herein.

FIG. 18B illustrates the example device of FIG. 18A further configured to deposit chemicals into a body of water as disclosed herein.

FIG. 19A illustrates an example device configured to emit disinfecting light into a body of water and emit disinfecting light above the body of water as disclosed herein.

FIG. 19B illustrates the example device FIG. 19A further configured to deposit chemicals into a body of water as disclosed herein.

FIG. 20 illustrates an example device comprising thermal management features and configured to emit disinfecting light into a body of water as disclosed herein.

### DETAILED DESCRIPTION

In the following description of the various embodiments, reference is made to the accompanying drawings, which form a part hereof, and in which is shown by way of illustration, various embodiments of the disclosure that may be practiced. It is to be understood that other embodiments may be utilized.

Wavelengths of visible light in the violet range, 380-420 nanometer (nm) (e.g., 405 nm), may have a lethal effect on microorganisms. As used herein, the term “microorganisms” encompasses at least viruses (including enveloped and non-enveloped viruses), bacteria (including gram-positive and gram-negative bacteria), bacterial endospores, yeasts, molds, and filamentous fungi. For example, Escherichia coli (E. coli), Salmonella, Methicillin-resistant Staphylococcus aureus (MRSA), and Clostridium difficile may be susceptible to 380-420 nm light. Such wavelengths may initiate a photoreaction within non-iron porphyrin molecules found in some microorganisms. The non-iron porphyrin molecules may be photoactivated and may react with other cellular components to produce Reactive Oxygen Species (ROS). ROS may cause irreparable cell damage and eventually destroy, kill, or otherwise inactivate cells of some microorganisms. Non-iron porphyrins are specific to microorganisms only therefore because humans, plants, and/or animals do not contain these same non-iron porphyrin molecules, this technique may be completely safe for human, plant, and animal exposure. Light in the 380-420 nm wavelength may be effective against every type of bacteria, although it may take different amounts of time or dosages depending upon the species. 380-420 nm light (e.g., 405 nm), may be effective against all gram-negative and gram-positive bacteria to some extent over a period of time. It can also be effective against many varieties of fungi.

In some examples, visible light in the violet range, 380-420 nanometer (nm) (e.g., 405 nm), may decrease viral load on a surface. Viruses may rely on surface bacteria, yeast, mold, or fungi as hosts. By decreasing surface bacteria, yeast, mold, or fungi count, for example, by using 380-420 nm light, the viral load may also be decreased. In some examples, viruses may be susceptible to reactive oxygen species. Viral load may decrease when the viruses are surrounded by a medium that can produce reactive oxygen species to inactivate viruses. In some examples, the medium may comprise fluids or droplets that comprise bacteria or other particles that produce oxygen reactive species. In some examples, the medium may comprise respiratory droplets, saliva, feces, organic rich media, and/or blood plasma.

Example methods, devices, and systems described herein may use visible light (e.g., 380 nm-420 nm wavelength light, and/or a specific wavelength in the wavelength range) for disinfection. Visible light disinfection may be used for continuous, efficient, and effective decontamination of various surfaces, bodies of air, or bodies of liquid, such as water. Visible light disinfection may be simultaneous with normal operation and without interruption of other functions of the devices and/or appliances. Daily and/or terminal cleaning procedures may be supplemented with visible light disinfection to maintain cleanliness between such cleaning procedures. Visible light disinfection may be used, for example, to combat any new sources of contamination and/or to reduce growth rates of microorganisms that may left behind after typical cleaning procedures.

A variety of microorganisms may live in water and water systems including but not limited to viruses, bacteria, fungi, and protozoa. Water sources such as rivers, lakes, and groundwater create a suitable environment for microorganisms to thrive. Man-made systems such as plumbing, cooling towers, wastewater, pools, hot tubs, and spas may also be reservoirs of potentially dangerous microorganisms. Bacteria such as Legionella pneumophila and Escherichia coli can be introduced into water systems via fecal contamination. These organisms have been known to cause severe pneumonia and gastrointestinal infections, respectively. Pseudomonas aeruginosa bacteria may thrive in water and cause health issues, especially in those who are immunocompromised or have underlying medical issues. Pseudomonas bacteria are ubiquitous in nature and may survive and colonize on surfaces and form biofilms which can be challenging to treat. These biofilms consist of polysaccharides, proteins, enzymes, and lipids composing an extracellular polymeric matrix—a complex structure that allows for the tolerance of concentrated antimicrobial exposure.

Biofilms in water systems may be extremely challenging to deal with due to the reduction in the effectiveness of disinfectants which shields the bacteria from numerous cleaning agents. Therefore, the presence of Pseudomonas in water can pose a risk in health care settings leading to a contribution of nosocomial infections and outbreaks if there are not proper water management controls and cleaning protocols in place. Viruses such as hepatitis A and norovirus may also contaminate water systems through fecal-oral transmission that can lead to gastroenteritis and hepatitis. Protozoa such as Giardia lamblia and Cryptosporidium spp. may cause severe gastrointestinal illnesses and have been known to be resistant to many disinfectant methods. Fungi such as Aspergillus spp. and Cryptococcus neoformans may thrive in water systems, particularly in warm and moist environments, and pose risks to immunocompromised individuals. Water may be a favorable environment that may promote growth and biofilms highlighting the importance of new and innovative ways of water treatment for public health.

According to a study published by the CDC, surveillance data taken from 2000-2015 noted that over 17 different microorganisms deemed as waterborne pathogens were responsible for diseases and illness including: campylobacteriosis, cryptosporidiosis, giardiasis, legionnaires disease, non-tuberculous mycobacterial infection (NTM), norovirus infection, Pseudomonas pneumonia and septicemia, Shiga-toxin producing E. coli 0157 (STEC) infections, salmonellosis, shigellosis, vibriosis including infections by Vibrio alginolyticus, parahaemolyticus, vulnificus and other species.

Chlorine tolerance may be seen in bacteria. The exact reason for chlorine tolerance in bacteria is not well understood and more research is needed. It has been speculated that certain enzymes and membrane characteristics may play a role in chlorine resistance/tolerance. Bacteria can shield themselves from disinfectants by creating biofilms, especially in spaces that are difficult to disinfect. These biofilms allow the proliferation of the bacteria that will favor the replication rate versus kill rate of the disinfectants. This problem calls for a higher frequency of disinfecting agents needed, more cost and resource use, and a growing need of new ways to help protect the water systems to provide an overall better health outcome.

Chlorine resistant bacteria including certain strains of Pseudomonas aeruginosa and Mycobacterium spp., present significant problems for water treatment. The standard water treatment methods are deemed less effective due to the mechanisms these organisms use to survive. The presence of these microorganisms may lead to persistent contamination which increases the risk of waterborne illnesses, most particularly in immunocompromised individuals. Current methods to combat chlorine resistant bacteria in water systems include disinfection technologies such as UV-light, ozone, and other oxidation processes. The issue or area of concern is that these practices have limitations in terms of total cost, efficacy, and environmental impact. Regrowth of microorganisms may also be problematic even after secondary water treatments, and can occur due to the current disinfection methods being inefficient in eradicating microbes in question.

A wide variety of chemicals may be utilized to disinfect air, surfaces, and water such as chlorine-based disinfectants, ozone, hydrogen peroxide and quaternary ammonium compounds. Chlorine disinfectants such as sodium hypochlorite (bleach), chlorine gas and chloramines are effective by oxidizing and disrupting the cell membranes of microorganisms leading to cell death. Hydrogen peroxide and ozone disinfectants function as oxidizing agents by generating reactive oxygen species that damage microbial cells and proteins as well as reacting to organic and inorganic compounds leading to microbial inactivation through oxidation. Quaternary ammonium compounds disrupt cellular functions and cell membranes leading to microbial death. In water treatment, the mechanism of kill involves the disruption of the microbial membranes, damage to DNA, denaturing of cellular proteins, structures, and functions, leading to cell lysis, microbial inactivation, and death. Similarly, in surface and air disinfection, chemical agents act by disrupting cellular processes causing irreversible damage, therefore eliminating microbial contaminants which reduce the risk of infection transmission.

Ultraviolet radiation (UV) may be used for disinfection and sanitization of bodies of water. UV radiation may be suitable for enclosed environments, such as water treatment plants, where exposure to humans can be prevented. Additionally, UV is suited for applications where material degradation is not a concern. If material degradation or human exposure is a concern, UV may not be an appropriate method for disinfection in that application.

In some examples, water turbidity may inhibit antimicrobial action of UV by blocking penetration of UV. This may require longer periods of UV exposure to provide an efficacious treatment. Disinfecting visible light may be a suitable alternative to UV disinfection because of the safe continuous use to provide an efficacious outcome.

Chemicals may be combined with visible disinfecting light, specifically in the wavelength range of 380 to 420 nanometers (nm), to provide disinfection or sanitization to bodies of water such as pools, spas, and hot tubs. Using visible disinfecting light in addition to chemicals may reduce the amount of chemicals required to reach the same microbial reductions. Using visible disinfecting light in addition to chemicals may reduce the frequency the chemicals need to be introduced to the body of water.

Visible disinfecting light may also help combat chlorine resistant microorganisms by providing a continuous method of disinfection at a low resource and energy cost. In some examples, less chemicals may be required for bacterial kill when used in combination with visible disinfecting light. The use of visible disinfecting light may reduce the amount of chemicals needed to treat water systems which reduces the overall resources of disinfection, providing a potentially healthier option of water treatment.

In some examples, inactivation, in relation to microorganism death, may include control and/or reduction in microorganism colonies or individual cells when exposed to disinfecting light for a certain duration. Light may be utilized for inactivation using a peak wavelength of light, or in some examples, multiple peak wavelengths, in a range of approximately 380 nm to 420 nm. For example, approximately 405 nm light may be used as the peak wavelength. It should be understood that any wavelength within 380 nm to 420 nm may be utilized, and that the peak wavelength may include a specific wavelength plus or minus approximately 5 nm. According to one example, peak wavelength may include, for example, at least, greater than, less than, equal to, or any number in between about 375 nm, 376 nm, 377 nm, 378 nm, 379 nm, 380 nm, 381 nm, 382 nm, 383 nm, 384 nm, 385 nm, 386 nm, 387 nm, 388 nm, 389 nm, 390 nm, 391 nm, 392 nm, 393 nm, 394 nm, 395 nm, 396 nm, 397 nm, 398 nm, 399 nm, 400 nm, 401 nm, 402 nm, 403 nm, 404 nm, 405 nm, 406 nm, 407 nm, 408 nm, 409 nm, 410 nm, 411 nm, 412 nm, 413 nm, 414 nm, 415 nm, 416 nm, 417 nm, 418 nm, 419 nm, 420 nm, 421 nm, 422 nm, 423 nm, 424 nm, and 425 nm. Such light may damage viral capsids, surface proteins, nucleic acids, and also lead to the degradation of the nucleic acids. Destruction of nucleic acids and genomes may prevent replication function in host cells leading to loss of infectivity. Unsaturated lipids and alterations of envelope proteins may cause conformational changes in the viral structure that alters viral interactions with host cell receptors. Protein mediated binding, injection or replication functions may be impaired. Significant changes in molecular mass and charge of proteins may occur, which may hinder viral entry and cytopathic effects.

The electromagnetic spectrum may be harnessed within devices, systems, and apparatuses to utilize its functions for benefit of humans/animals. Most portions of the electromagnetic spectrum are not visible with the exception of the visible light spectrum within the range of approximately 380 nm to 750 nm. The ultraviolet spectrum comprises the energy within the range of approximately 100 nm to 400 nm and is generally not visible. Light comprising wavelengths that provide microbial inactivation or disinfection may be referred to as “disinfecting light.” Disinfecting light may be emitted by one or more light emitters.

There may be a minimum irradiance required to hit the surface to cause microbial inactivation. A target irradiance may be required on at least a portion of the surface. A minimum irradiance of light (e.g., in the 380-420 nm wavelength) on a surface may cause microbial inactivation. For example, a minimum irradiance of 0.02 milliwatts per square centimeter (mW/cm²) may cause microbial inactivation on a surface over time. In some examples, an irradiance of 0.05 mW/cm² may inactivate microorganisms on a surface, but higher values such as 0.1 mW/cm², 0.5 mW/cm², 1 mW/cm², or 2 mW/cm² may be used for quicker microorganism inactivation. In some examples, even higher irradiances may be used over shorter periods of time, e.g., 3 to 10 mW/cm². In other examples, a target irradiance may be, for example, at least, greater than, less than, equal to, or any number in between about 0.01 mW/cm², 0.02 mW/cm², 0.03 mW/cm², 0.04 mW/cm², 0.05 mW/cm², 0.06 mW/cm², 0.07 mW/cm², 0.08 mW/cm², 0.09 mW/cm², 0.1 mW/cm², 0.1 mW/cm², 0.2 mW/cm², 0.3 mW/cm², 0.4 mW/cm², 0.5 mW/cm², 0.6 mW/cm², 0.7 mW/cm², 0.8 mW/cm², 0.9 mW/cm², 1.0 mW/cm², 1.1 mW/cm², 1.2 mW/cm², 1.3 mW/cm², 1.4 mW/cm², 1.5 mW/cm², 1.6 mW/cm², 1.7 mW/cm², 1.8 mW/cm², 1.9 mW/cm², 2.0 mW/cm², 2.1 mW/cm², 2.2 mW/cm², 2.3 mW/cm², 2.4 mW/cm², 2.5 mW/cm², 2.6 mW/cm², 2.7 mW/cm², 2.8 mW/cm², 2.9 mW/cm², 3.0 mW/cm², 3.1 mW/cm², 3.2 mW/cm², 3.3 mW/cm², 3.4 mW/cm², 3.5 mW/cm², 3.6 mW/cm², 3.7 mW/cm², 3.8 mW/cm², 3.9 mW/cm², 4.0 mW/cm², 4.1 mW/cm², 4.2 mW/cm², 4.3 mW/cm², 4.4 mW/cm², 4.5 mW/cm², 4.6 mW/cm², 4.7 mW/cm², 4.8 mW/cm², 4.9 mW/cm², 5.0 mW/cm², 5.1 mW/cm², 5.2 mW/cm², 5.3 mW/cm², 5.4 mW/cm², 5.5 mW/cm², 5.6 mW/cm², 5.7 mW/cm², 5.8 mW/cm², 5.9 mW/cm², 6.0 mW/cm², 6.1 mW/cm², 6.2 mW/cm², 6.3 mW/cm², 6.4 mW/cm², 6.5 mW/cm², 6.6 mW/cm², 6.7 mW/cm², 6.8 mW/cm², 6.9 mW/cm², 7.0 mW/cm², 7.1 mW/cm², 7.2 mW/cm², 7.3 mW/cm², 7.4 mW/cm², 7.5 mW/cm², 7.6 mW/cm², 7.7 mW/cm², 7.8 mW/cm², 7.9 mW/cm², 8.0 mW/cm², 8.1 mW/cm², 8.2 mW/cm², 8.3 mW/cm², 8.4 mW/cm², 8.5 mW/cm², 8.6 mW/cm², 8.7 mW/cm², 8.8 mW/cm², 8.9 mW/cm², 9.0 mW/cm², 9.1 mW/cm², 9.2 mW/cm², 9.3 mW/cm², 9.4 mW/cm², 9.5 mW/cm², 9.6 mW/cm², 9.7 mW/cm², 9.8 mW/cm², 9.9 mW/cm², and 10.0 mW/cm². Example light emitters disclosed herein may be configured to produce light with such irradiances at any given surface.

In some examples, an average irradiance is targeted across a surface or at least a portion of a surface. The average may comprise an average of multiple measurement points taken across at least a portion of the surface. Irradiance measurements may range from 0 mW/cm² to 100 mW/cm² in some examples. In some examples, the target average irradiance may be 0.05 mW/cm². In some examples, the target average irradiance may be 1 mW/cm². In some examples, the target average irradiance may be any value within the range of 0.02 to 2 mW/cm². In some examples, the target average irradiance may be any value within the range of 0.02 to 5 mW/cm². In still another example, the average irradiance may be, for example, at least, greater than, less than, equal to, or any number in between about 0.01 mW/cm², 0.02 mW/cm², 0.03 mW/cm², 0.04 mW/cm², 0.05 mW/cm², 0.06 mW/cm², 0.07 mW/cm², 0.08 mW/cm², 0.09 mW/cm², 0.1 mW/cm², 0.1 mW/cm², 0.2 mW/cm², 0.3 mW/cm², 0.4 mW/cm², 0.5 mW/cm², 0.6 mW/cm², 0.7 mW/cm², 0.8 mW/cm², 0.9 mW/cm², 1.0 mW/cm², 1.1 mW/cm², 1.2 mW/cm², 1.3 mW/cm², 1.4 mW/cm², 1.5 mW/cm², 1.6 mW/cm², 1.7 mW/cm², 1.8 mW/cm², 1.9 mW/cm², 2.0 mW/cm², 2.1 mW/cm², 2.2 mW/cm², 2.3 mW/cm², 2.4 mW/cm², 2.5 mW/cm², 2.6 mW/cm², 2.7 mW/cm², 2.8 mW/cm², 2.9 mW/cm², 3.0 mW/cm², 3.1 mW/cm², 3.2 mW/cm², 3.3 mW/cm², 3.4 mW/cm², 3.5 mW/cm², 3.6 mW/cm², 3.7 mW/cm², 3.8 mW/cm², 3.9 mW/cm², 4.0 mW/cm², 4.1 mW/cm², 4.2 mW/cm², 4.3 mW/cm², 4.4 mW/cm², 4.5 mW/cm², 4.6 mW/cm², 4.7 mW/cm², 4.8 mW/cm², 4.9 mW/cm², 5.0 mW/cm², 5.1 mW/cm², 5.2 mW/cm², 5.3 mW/cm², 5.4 mW/cm², 5.5 mW/cm², 5.6 mW/cm², 5.7 mW/cm², 5.8 mW/cm², 5.9 mW/cm², 6.0 mW/cm², 6.1 mW/cm², 6.2 mW/cm², 6.3 mW/cm², 6.4 mW/cm², 6.5 mW/cm², 6.6 mW/cm², 6.7 mW/cm², 6.8 mW/cm², 6.9 mW/cm², 7.0 mW/cm², 7.1 mW/cm², 7.2 mW/cm², 7.3 mW/cm², 7.4 mW/cm², 7.5 mW/cm², 7.6 mW/cm², 7.7 mW/cm², 7.8 mW/cm², 7.9 mW/cm², 8.0 mW/cm², 8.1 mW/cm², 8.2 mW/cm², 8.3 mW/cm², 8.4 mW/cm², 8.5 mW/cm², 8.6 mW/cm², 8.7 mW/cm², 8.8 mW/cm², 8.9 mW/cm², 9.0 mW/cm², 9.1 mW/cm², 9.2 mW/cm², 9.3 mW/cm², 9.4 mW/cm², 9.5 mW/cm², 9.6 mW/cm², 9.7 mW/cm², 9.8 mW/cm², 9.9 mW/cm², and 10.0 mW/cm².

In some examples, light for microbial inactivation may include radiometric energy sufficient to inactivate at least one microorganism population, or in some examples, a plurality of microorganism populations. One or more light emitters(s) may emit some minimum amount of radiometric energy (e.g., 20 mW) measured from 380-420 nm light. In one example, one or more light emitter(s) may emit some minimum amount of radiometric energy measured from, for example, at least, greater than, less than, equal to, or any number in between about 375 nm, 376 nm, 377 nm, 378 nm, 379 nm, 380 nm, 381 nm, 382 nm, 383 nm, 384 nm, 385 nm, 386 nm, 387 nm, 388 nm, 389 nm, 390 nm, 391 nm, 392 nm, 393 nm, 394 nm, 395 nm, 396 nm, 397 nm, 398 nm, 399 nm, 400 nm, 401 nm, 402 nm, 403 nm, 404 nm, 405 nm, 406 nm, 407 nm, 408 nm, 409 nm, 410 nm, 411 nm, 412 nm, 413 nm, 414 nm, 415 nm, 416 nm, 417 nm, 418 nm, 419 nm, 420 nm, 421 nm, 422 nm, 423 nm, 424 nm, and 425 nm.

In another example, one or more light emitter(s) may emit some minimum amount of radiometric energy measured from, for example, at least, greater than, less than, equal to, or any number in between about 10 mW, 15 mW, 20 mW, 25 mW, 30 mW, 35 mW, 40 mW, 45 mW, 50 mW, 55 mW, 60 mW, 65 mW, 70 mW, 75 mW, 80 mW, 85 mW, 90 mW, 95 mW, 100 mW, 105 mW, 110 mW, 115 mW, 120 mW, 125 mW, 130 mW, 135 mW, 140 mW, 145 mW, 150 mW, 155 mW, 160 mW, 165 mW, 170 mW, 175 mW, 180 mW, 185 mW, 190 mW, 195 mW, 200 mW, 205 mW, 210 mW, 215 mW, 220 mW, 225 mW, 230 mW, 235 mW, 240 mW, 245 mW, 250 mW, 255 mW, 260 mW, 265 mW, 270 mW, 275 mW, 280 mW, 285 mW, 290 mW, 295 mW, 300 mW, 305 mW, 310 mW, 315 mW, 320 mW, 325 mW, 330 mW, 335 mW, 340 mW, 345 mW, 350 mW, 355 mW, 360 mW, 365 mW, 370 mW, 375 mW, 380 mW, 385 mW, 390 mW, 395 mW, 400 mW, 405 mW, 410 mW, 415 mW, 420 mW, 425 mW, 430 mW, 435 mW, 440 mW, 445 mW, 450 mW, 455 mW, 460 mW, 465 mW, 470 mW, 475 mW, 480 mW, 485 mW, 490 mW, 495 mW, 500 mW, 505 mW, 510 mW, 515 mW, 520 mW, 525 mW, 530 mW, 535 mW, 540 mW, 545 mW, 550 mW, 555 mW, 560 mW, 565 mW, 570 mW, 575 mW, 580 mW, 585 mW, 590 mW, 595 mW, 600 mW, 605 mW, 610 mW, 615 mW, 620 mW, 625 mW, 630 mW, 635 mW, 640 mW, 645 mW, 650 mW, 655 mW, 660 mW, 665 mW, 670 mW, 675 mW, 680 mW, 685 mW, 690 mW, 695 mW, 700 mW, 705 mW, 710 mW, 715 mW, 720 mW, 725 mW, 730 mW, 735 mW, 740 mW, 745 mW, 750 mW, 755 mW, 760 mW, 765 mW, 770 mW, 775 mW, 780 mW, 785 mW, 790 mW, 795 mW, 800 mW, 805 mW, 810 mW, 815 mW, 820 mW, 825 mW, 830 mW, 835 mW, 840 mW, 845 mW, 850 mW, 855 mW, 860 mW, 865 mW, 870 mW, 875 mW, 880 mW, 885 mW, 890 mW, 895 mW, 900 mW, 905 mW, 910 mW, 915 mW, 920 mW, 925 mW, 930 mW, 935 mW, 940 mW, 945 mW, 950 mW, 955 mW, 960 mW, 965 mW, 970 mW, 975 mW, 980 mW, 985 mW, 990 mW, 995 mW, 1000 mW, 1005 mW, 1010 mW, 1015 mW, 1020 mW, 1025 mW, 1030 mW, 1035 mW, 1040 mW, 1045 mW, 1050 mW, 1055 mW, 1060 mW, 1065 mW, 1070 mW, 1075 mW, 1080 mW, 1085 mW, 1090 mW, 1095 mW, 1100 mW, 1105 mW, 1110 mW, 1115 mW, 1120 mW, 1125 mW, 1130 mW, 1135 mW, 1140 mW, 1145 mW, 1150 mW, 1155 mW, 1160 mW, 1165 mW, 1170 mW, 1175 mW, 1180 mW, 1185 mW, 1190 mW, 1195 mW, 1200 mW, 1205 mW, 1210 mW, 1215 mW, 1220 mW, 1225 mW, 1230 mW, 1235 mW, 1240 mW, 1245 mW, 1250 mW, 1255 mW, 1260 mW, 1265 mW, 1270 mW, 1275 mW, 1280 mW, 1285 mW, 1290 mW, 1295 mW, 1300 mW, 1305 mW, 1310 mW, 1315 mW, 1320 mW, 1325 mW, 1330 mW, 1335 mW, 1340 mW, 1345 mW, 1350 mW, 1355 mW, 1360 mW, 1365 mW, 1370 mW, 1375 mW, 1380 mW, 1385 mW, 1390 mW, 1395 mW, 1400 mW, 1405 mW, 1410 mW, 1415 mW, 1420 mW, 1425 mW, 1430 mW, 1435 mW, 1440 mW, 1445 mW, 1450 mW, 1455 mW, 1460 mW, 1465 mW, 1470 mW, 1475 mW, 1480 mW, 1485 mW, 1490 mW, 1495 mW, 1500 mW, 1505 mW, 1510 mW, 1515 mW, 1520 mW, 1525 mW, 1530 mW, 1535 mW, 1540 mW, 1545 mW, 1550 mW, 1555 mW, 1560 mW, 1565 mW, 1570 mW, 1575 mW, 1580 mW, 1585 mW, 1590 mW, 1595 mW, 1600 mW, 1605 mW, 1610 mW, 1615 mW, 1620 mW, 1625 mW, 1630 mW, 1635 mW, 1640 mW, 1645 mW, 1650 mW, 1655 mW, 1660 mW, 1665 mW, 1670 mW, 1675 mW, 1680 mW, 1685 mW, 1690 mW, 1695 mW, 1700 mW, 1705 mW, 1710 mW, 1715 mW, 1720 mW, 1725 mW, 1730 mW, 1735 mW, 1740 mW, 1745 mW, 1750 mW, 1755 mW, 1760 mW, 1765 mW, 1770 mW, 1775 mW, 1780 mW, 1785 mW, 1790 mW, 1795 mW, 1800 mW, 1805 mW, 1810 mW, 1815 mW, 1820 mW, 1825 mW, 1830 mW, 1835 mW, 1840 mW, 1845 mW, 1850 mW, 1855 mW, 1860 mW, 1865 mW, 1870 mW, 1875 mW, 1880 mW, 1885 mW, 1890 mW, 1895 mW, 1900 mW, 1905 mW, 1910 mW, 1915 mW, 1920 mW, 1925 mW, 1930 mW, 1935 mW, 1940 mW, 1945 mW, 1950 mW, 1955 mW, 1960 mW, 1965 mW, 1970 mW, 1975 mW, 1980 mW, 1985 mW, 1990 mW, 1995 mW, and 2000 mW.

Dosage (measured in Joules/cm²) may be another metric for determining an appropriate irradiance for microbial inactivation over a period of time. Table 1 below shows example correlations between irradiance in mW/cm² and Joules/cm² based on different exposure times. These values are examples, and many others may be possible.

TABLE 1

| Irradiance | Exposure Time | Dosage |
|---|---|---|
| (mW/cm²) | (hours) | (Joules/cm²) |
| 0.02 | 1 | 0.072 |
| 0.02 | 24 | 1.728 |
| 0.02 | 250 | 18 |
| 0.02 | 500 | 36 |
| 0.02 | 1000 | 72 |
| 0.05 | 1 | 0.18 |
| 0.05 | 24 | 4.32 |
| 0.05 | 250 | 45 |
| 0.05 | 500 | 90 |
| 0.05 | 1000 | 180 |
| 0.1 | 1 | 0.36 |
| 0.1 | 24 | 8.64 |
| 0.1 | 250 | 90 |
| 0.1 | 500 | 180 |
| 0.1 | 1000 | 360 |
| 0.5 | 1 | 1.8 |
| 0.5 | 24 | 43.2 |
| 0.5 | 250 | 450 |
| 0.5 | 500 | 900 |
| 0.5 | 1000 | 1800 |
| 1 | 1 | 3.6 |
| 1 | 24 | 86.4 |
| 1 | 250 | 900 |
| 1 | 500 | 1800 |
| 1 | 1000 | 3600 |
| 2 | 1 | 7.2 |
| 2 | 24 | 172.8 |
| 2 | 250 | 1800 |
| 2 | 500 | 3600 |
| 2 | 1000 | 7200 |
| 5 | 1 | 18 |
| 5 | 24 | 432 |
| 5 | 250 | 4500 |
| 5 | 500 | 9000 |
| 5 | 1000 | 18000 |

Microbial inactivation may comprise a target reduction in microorganism population(s) (e.g., 1-Log₁₀ reduction, 2-Log₁₀ reduction, 99% reduction, or the like). Table 2 shows example dosages recommended for the inactivation (measured as 1-Log₁₀ reduction in population) of different microorganism species using narrow spectrum 405 nm light. Example dosages and other calculations shown herein may be determined based on laboratory settings. Real world applications may require dosages that may differ from example laboratory data. Other dosages of 380-420 nm (e.g., 405 nm) light may be used with other bacteria not listed below.

TABLE 2

| | Recommended Dose (J/cm²) for 1-Log |
|---|---|
| Microorganism | Reduction in Microorganism |
| Staphylococcus aureus | 20 |
| MRSA | 20 |
| Pseudomonas aeruginosa | 45 |
| Escherichia coli | 80 |
| Enterococcus faecalis | 90 |

Equation 1 may be used in order to determine irradiance, dosage, or time using one or more data points from Table 1 and Table 2:

$$\frac{Irradiance ( \frac{mW}{{cm}^{2}} )}{1000} * Time ( s ) = Dosage ( \frac{J}{{cm}^{2}} ) \qquad Equation 1$$

Irradiance may be determined based on dosage and time. For example, if a dosage of 30 Joules/cm² is recommended and the object desired to be disinfected is exposed to light overnight for 8 hours, the irradiance may be approximately 1 mW/cm². If a dosage of 50 Joules/cm² is recommended and the object desired to be disinfected is exposed to light for 48 hours, a smaller irradiance of only approximately 0.3 mW/cm² may be sufficient.

Time may be determined based on irradiance and dosage. For example, light emitter(s) may be configured to provide an irradiance of disinfecting energy (e.g., 0.05 mW/cm²) and a target bacteria may require a dosage of 20 Joules/cm² to kill the target bacteria. Disinfecting light at 0.05 mW/cm² may have a minimum exposure time of approximately 4.6 days to achieve the dosage of 20 Joules/cm². Dosage values may be determined by a target reduction in microorganisms. Once the microorganism count is reduced to a desired amount, disinfecting light may be continuously applied to keep the microorganism counts down.

Radiant power (e.g., radiometric power, optical output power, spectral power etc.), measured in Watts, is the total power emitted from a light source. Irradiance is the power per unit area on a surface at a distance away from the light source. In some examples, the target irradiance on a target surface from the light source may be 10 mW/cm². A 10 mW/cm² target irradiance may be provided, for example, by light emitter(s) with a total radiant power of 10 mW located 1 cm from the target surface. In another example, light emitter(s) may be located 5 cm from the target surface. With a target irradiance of 10 mW/cm², the light source may be configured to produce a radiant power approximately 250 mW. These calculations may be approximately based on the inverse square law, as shown in Equation 1, where the excitation light source may be assumed to be a point source, E is the irradiance, I is the radiant power, and r is the distance from the excitation light source to a target surface.

$$E ≅ \frac{I}{{r}^{2}} \qquad Equation 2$$

In some examples, different wavelengths of light may have different effects on different microorganisms. The tables below illustrate example data related to application of various wavelengths of light on various microorganisms. For example, tables 3-7 summarize the recommended dose response for the inactivation of microorganisms at different log levels when exposed to wavelengths of 405 nm, 222 nm and 254 nm light. Inactivation may comprise a target reduction in microorganism population(s) (e.g., 1-Log₁₀ reduction, 2-Log₁₀ reduction, 99% reduction, or the like).

Table 3 shows example dosages measured in J/cm² which may be used for the inactivation (at different log levels) of different microorganisms using 222 nm light.

TABLE 3

| | Recommended Dose (J/cm²) for Reduction in Microorganisms at 222 nm | | | |
|---|---|---|---|---|
| Microorganism | 1-log | 2-log | 3-log | 4-log |
| Staphylococcus | 9.3 × 10⁻³ | 1.15 × 10⁻² | 1.38 × 10⁻² | 1.78 × 10⁻² |
| aureus | | | | |
| Pseudomonas | 3.1 × 10⁻³ | 4.8 × 10⁻³ | 5.9 × 10⁻³ | 7.5 × 10⁻³ |
| aeruginosa | | | | |
| Aspergillus | 9 × 10⁻² | 0.220 | 0.325 | 0.430 |
| niger | | | | |

Table 4 shows example dosages measured in J/cm² which may be used for the inactivation (at different log levels) of different microorganisms using 254 nm light.

TABLE 4

| | Recommended Dose (J/cm²) for Reduction in Microorganisms at 254 nm | | | |
|---|---|---|---|---|
| Microorganism | 1-log | 2-log | 3-log | 4-log |
| Staphylococcus | 4.4 × 10⁻³ | 6.0 × 10⁻³ | 7.3 × 10⁻³ | 9.5 × 10⁻³ |
| aureus | | | | |
| Streptococcus | 6.6 × 10⁻³ | 8.8 × 10⁻³ | 9.9 × 10⁻³ | 1.12 × 10⁻² |
| faecalis | | | | |
| Pseudomonas | 8 × 10⁻⁴ | 1.6 × 10⁻³ | 2.3 × 10⁻³ | 3.1 × 10⁻³ |
| aeruginosa | | | | |
| Escherichia coli | 3 × 10⁻³ | 4.8 × 10⁻³ | 6.7 × 10⁻³ | 8.4 × 10⁻³ |
| Aspergillus | 0.115 | 0.245 | 0.370 | 0.560 |
| niger | | | | |

Table 5 shows example dosages measured in J/cm² which may be used for the inactivation (at different log levels) of different microorganisms using 222 nm light.

TABLE 5

| | Recommended Dose (J/cm²) for Reduction in Microorganisms at 222 nm | | | |
|---|---|---|---|---|
| Microorganism | Type | Reduction | Light dosage | Medium |
| Influenza A | Enveloped | 1 log | 1.3 × 10⁻³ | Airborne |
| | | 2 log | 2.6 × 10⁻³ | |
| | | 3 log | 3.8 × 10⁻³ | |
| HCoV 229-E | Enveloped | 1 log | 5.6 × 10⁻⁴ | Airborne |
| | | 2 log | 1.1 × 10⁻³ | |
| | | 3 log | 1.7 × 10⁻³ | |
| HCoV OCV3 | Enveloped | 1 log | 3.9 × 10⁻⁴ | Airborne |
| | | 2 log | 7.8 × 10⁻⁴ | |
| | | 3 log | 1.2 × 10⁻³ | |

Table 6 shows example dosages measured in J/cm² which may be used for the inactivation (at different log levels) of different microorganisms using 254 nm light.

TABLE 6

| | Recommended Dose (J/cm²) for Reduction in Microorganisms at 254 nm | | | |
|---|---|---|---|---|
| Microorganism | Type | Reduction | Light dosage | Medium |
| Influenza A | Enveloped | 1 log | 1.04 × 10⁻³ | Airborne |
| | | 1.4 log | 1.48 × 10⁻³ | |
| Influenza A | Enveloped | 4.08 log to | 1.8 | Solid |
| | | 5.75 log | | |
| SARS CoV | Enveloped | 3.4 log to | 0.15 | Liquid |
| | | 3.6 log | 1.4 | |
| | | 4 log | | |
| SARS CoV | Enveloped | 4 log | 0.12 | Solid |
| SARS CoV2 | Enveloped | 5.7 log | 1.6 × 10⁻² | Liquid |
| MS₂ | Non-enveloped | 1 log | 3.4-4.2 × 10⁻⁴ | Airborne |
| bacteriophage | | 2 log | 8-9.1 × 10⁻⁴ | |
| MS₂ | Non-enveloped | 1 log | 1.86-2.57 × 10⁻² | Liquid |
| bacteriophage | | 4 log | 0.12 | |
| MS2 | Non-enveloped | 1 log | 3.2 × 10⁻³ | Solid |
| bacteriophage | | 3 log to 4 log | 4.32-7.2 | |
| FCV | Non-enveloped | 1 log | 5-6 × 10⁻³ | Liquid |
| | | 4 log | 0.04 | |
| FCV | Non-Enveloped | 2.12 log-4.46 | 0.2 | Solid |
| | | log | | |
| Adenovirus type | Non-enveloped | 1 log | 5.5 × 10⁻² | Liquid |
| 40 | | 2 log | 0.105 | |
| | | 3 log | 0.155 | |
| Rotavirus | Non-enveloped | 1 log | 2.0 × 10⁻² | Liquid |
| | | 2 log | 8.0 × 10⁻² | |
| | | 3 log | 0.140 | |
| | | 4 log | 0.2 | |
| Polio virus 1 | Non-enveloped | 1 log | 7 × 10⁻³ | Liquid |
| | | 2 log | 1.7 × 10⁻² | |
| | | 3 log | 2.8 × 10⁻² | |
| | | 4 log | 3.7 × 10⁻² | |
| Hepatitis A | Non-enveloped | 1 log | 5.5 × 10⁻³ | Liquid |
| | | 2 log | 9.8 × 10⁻³ | |
| | | 3 log | 1.5 × 10⁻² | |
| | | 4 log | 2.1 × 10⁻² | |
| Murine | Non-enveloped | 1 log | 1 × 10⁻² | Liquid |
| norovirus | | | | |

Table 7 shows example dosages measured in J/cm² which may be used for the inactivation (at different log levels) of different microorganisms using 405 nm light.

TABLE 7

| | Recommended Dose (J/cm²) for Reduction in Microorganisms at 405 nm | | | |
|---|---|---|---|---|
| | | | Light | |
| Microorganism | Type | Reduction | dosage | Medium |
| SARS CoV2 | Enveloped | 1 log | 3.9 × 10⁻⁴ | Airborne |
| phi6 | Enveloped | 1 log | 430 | Liquid |
| | | 3 log | 1300 | |
| Bacteriophage sigma | Non-Enveloped | 3 log | 300 | Liquid |
| C31 | | 5 log | 500 | |
| | | 7 log | 1400 | |
| FCV | Non-enveloped | 3.9 log | 2800 | Liquid |

A maximum chlorine concentration of 4 mg/L or (4 ppm) is recommended for water disinfection according to the CDC and EPA. The CDC recommends a free chlorine concentration of at least 1 mg/L (ppm) in pools and at least 3 mg/L (ppm) in hot tubs and spas. If chlorine stabilizers such as cyanuric acid are used, then a minimum of 2 mg/L (ppm) in pools but does not recommend using such stabilizers in hot tubs or spas.

It is recommended to check the free chlorine availability at least twice a day for pools. Chlorine is added to pools and spas as frequently as once a day to once a week depending on the type of chlorine used. Other contributing factors include sunlight as it can break down chlorine upon exposure requiring a more frequent treatment regimen to ensure a safe water system.

The bromine concentration recommendations in accordance with the standards (ANSI/APSP/ICC-11) for water quality in public pools is 3-4 mg/L (ppm) and 4-6 mg/L (ppm) in spas.

Cyanuric acid is a chlorine stabilizer that prevents chlorine from breaking down by sunlight (UV). The ideal level for pools is 30-40 mg/L (ppm), and 30-50 mg/L (ppm) in spas.

The addition of visible disinfecting light with a peak wavelength at 405 nm at an irradiance of approximately 1 mW/cm² in combination with sodium hypochlorite may provide more kill with less sodium hypochlorite when compared to the use of sodium hypochlorite alone. Evidence shows that visible disinfecting light in combination with sodium hypochlorite provides a powerful tool in preventing growth and proliferation of illness causing bacteria. Sodium hypochlorite is an example chemical, others may be used. The combination of visible disinfecting light and chemicals may be more efficacious at lower concentrations of chemicals. The combination treatment of visible disinfecting light and chemicals may reduce the chemical load and improve antimicrobial efficacy. This may offer a dual benefit in hot tub and spa water management.

In some examples, one or more of the light emitter(s) disclosed herein may inactivate microorganisms/pathogens with light having a peak wavelength of light, or in some examples, multiple peak wavelengths, in a range of approximately 380 nm to approximately 420 nm. For example, approximately 405 nm light may be used as the peak wavelength. It should be understood that any wavelength within 380 nm to 420 nm may be utilized, and that the peak wavelength may include a specific wavelength plus or minus approximately 5 nm. In some examples, one or more light emitter(s) may emit some minimum amount of radiometric energy measured from, for example, at least, greater than, less than, equal to, or any number in between about 375 nm, 376 nm, 377 nm, 378 nm, 379 nm, 380 nm, 381 nm, 382 nm, 383 nm, 384 nm, 385 nm, 386 nm, 387 nm, 388 nm, 389 nm, 390 nm, 391 nm, 392 nm, 393 nm, 394 nm, 395 nm, 396 nm, 397 nm, 398 nm, 399 nm, 400 nm, 401 nm, 402 nm, 403 nm, 404 nm, 405 nm, 406 nm, 407 nm, 408 nm, 409 nm, 410 nm, 411 nm, 412 nm, 413 nm, 414 nm, 415 nm, 416 nm, 417 nm, 418 nm, 419 nm, 420 nm, 421 nm, 422 nm, 423 nm, 424 nm, and 425 nm.

In some examples, one or more of the light emitter(s) disclosed herein may inactivate microorganisms/pathogens with light having a peak wavelength of light, or in some examples, multiple peak wavelengths, in a range of approximately 200 nm to approximately 380 nm, for example, approximately 254 nm light may be used as the peak wavelength. It should be understood that any wavelength within 200 nm to 380 nm may be utilized, and that the peak wavelength may include a specific wavelength plus or minus approximately 5 nm. Light sources may additionally be within the following ranges: 100-280 nm, 200-230 nm, and/or 380-420 nm including, for example, UVA, UVC, visible, 222 nm, 254 nm, 260-270 nm, 280 nm, and/or 405 nm peak wavelength. In another example, one or more of the light emitter(s) disclosed herein may inactivate microorganisms/pathogens with light having a peak wavelength of light, or in some examples, multiple peak wavelengths, in a range of, at least, greater than, less than, equal to, or any number in between about 200 nm, 201 nm, 202 nm, 203 nm, 204 nm, 205 nm, 206 nm, 207 nm, 208 nm, 209 nm, 210 nm, 211 nm, 212 nm, 213 nm, 214 nm, 215 nm, 216 nm, 217 nm, 218 nm, 219 nm, 220 nm, 221 nm, 222 nm, 223 nm, 224 nm, 225 nm, 226 nm, 227 nm, 228 nm, 229 nm, 230 nm, 231 nm, 232 nm, 233 nm, 234 nm, 235 nm, 236 nm, 237 nm, 238 nm, 239 nm, 240 nm, 241 nm, 242 nm, 243 nm, 244 nm, 245 nm, 246 nm, 247 nm, 248 nm, 249 nm, 250 nm, 251 nm, 252 nm, 253 nm, 254 nm, 255 nm, 256 nm, 257 nm, 258 nm, 259 nm, 260 nm, 261 nm, 262 nm, 263 nm, 264 nm, 265 nm, 266 nm, 267 nm, 268 nm, 269 nm, 270 nm, 271 nm, 272 nm, 273 nm, 274 nm, 275 nm, 276 nm, 277 nm, 278 nm, 279 nm, 280 nm, 281 nm, 282 nm, 283 nm, 284 nm, 285 nm, 286 nm, 287 nm, 288 nm, 289 nm, 290 nm, 291 nm, 292 nm, 293 nm, 294 nm, 295 nm, 296 nm, 297 nm, 298 nm, 299 nm, 300 nm, 301 nm, 302 nm, 303 nm, 304 nm, 305 nm, 306 nm, 307 nm, 308 nm, 309 nm, 310 nm, 311 nm, 312 nm, 313 nm, 314 nm, 315 nm, 316 nm, 317 nm, 318 nm, 319 nm, 320 nm, 321 nm, 322 nm, 323 nm, 324 nm, 325 nm, 326 nm, 327 nm, 328 nm, 329 nm, 330 nm, 331 nm, 332 nm, 333 nm, 334 nm, 335 nm, 336 nm, 337 nm, 338 nm, 339 nm, 340 nm, 341 nm, 342 nm, 343 nm, 344 nm, 345 nm, 346 nm, 347 nm, 348 nm, 349 nm, 350 nm, 351 nm, 352 nm, 353 nm, 354 nm, 355 nm, 356 nm, 357 nm, 358 nm, 359 nm, 360 nm, 361 nm, 362 nm, 363 nm, 364 nm, 365 nm, 366 nm, 367 nm, 368 nm, 369 nm, 370 nm, 371 nm, 372 nm, 373 nm, 374 nm, 375 nm, 376 nm, 377 nm, 378 nm, 379 nm, 380 nm, 381 nm, 382 nm, 383 nm, 384 nm, 385 nm, 386 nm, 387 nm, 388 nm, 389 nm, 390 nm, 391 nm, 392 nm, 393 nm, 394 nm, 395 nm, 396 nm, 397 nm, 398 nm, 399 nm, 400 nm, 401 nm, 402 nm, 403 nm, 404 nm, 405 nm, 406 nm, 407 nm, 408 nm, 409 nm, 410 nm, 411 nm, 412 nm, 413 nm, 414 nm, 415 nm, 416 nm, 417 nm, 418 nm, 419 nm, 420 nm, 421 nm, 422 nm, 423 nm, 424 nm, and 425 nm.

A device may be configured to provide visible light disinfection to a body of water. The device may float on the surface of a body of water and direct light down towards the body of water. In some examples, the device may direct light down towards the body of water and up towards any surfaces above the waterline such as the interior of a hot tub cover. The device may comprise a housing wherein a portion of the housing is above the surface of the body of water and a portion of the housing is below the surface of the body of water.

The device may be configured to deposit chemicals and provide visible light disinfection to a body of water. The device may comprise a compartment for tablets or liquid chemicals which automatically dispense into the body of water through dissolving or mechanical means. A mechanical and/or electrical apparatus or mechanism may be configured to deposit chemicals into the body of water. The device may direct disinfecting light down into the body of water and/or at surfaces above the waterline.

In some examples, the device may comprise only a disinfecting lighting element and not a chemical deposition element.

The disinfecting lighting element may be a light emitter, light fixture, luminaire, LED, circuit board disposed with LEDs, or any other form factor with the ability to emit light.

In some examples. The device may emit light. The device may comprise light emitters disposed within. The device may comprise light emitters disposed on a substrate such as a circuit board. In some examples, the device may comprise a circuit board populated with LEDs. In some examples, the device may comprise baffles or optics to direct the emitted light.

The chemical deposition element may be an electrical and/or mechanical mechanism for depositing chemicals into a body of water.

In some examples, the device may comprise an internal area for housing one or more light emitters that produce a disinfecting light. The light emitters may be disposed on a substrate such as a circuit board. In some examples, the light emitters are LEDs. The device may comprise a transparent or translucent lens positioned below the surface of the water or above the surface of the water. The device may be configured to float on the surface of the water. The device may comprise an air pocket above the waterline that allows it to float on the surface of the water. The device may comprise a foam-filled chamber that allows it to float on the surface of the water. While floating, a portion of the device may be configured to be above the waterline and a portion may be configured to be below the waterline. A compartment comprising a location for depositing chemicals may be below the waterline in some examples.

The surface of the water refers to the air water interface, waterline, and/or the top surface at which the body of water ends.

The device may be configured to be positioned in a pool or hot tub. The scale of the device may be designed for the application it is used within such as a pool or hot tub.

The device may be applied in any body of water including a pool, spa, hot tub, water treatment facility, water tank, etc. The device may be applied in bodies of liquids other than water.

The target for disinfection from the device may be the body of water the device is disposed within. In some examples, the target for disinfection may also include one or more surfaces of the item holding the body of water, such as a surface of a pool, hot tub, or spa. An example surface may be the bottom of a hot tub cover.

In some examples, the device may be an assembly of multiple components. The components may include but are not limited to a housing, lens, light emitters, power source, wiring, controller(s), compartment for chemicals, air pocket, power supply or LED driver, internal structure features, and access doors/points. In some examples the device may comprise a mechanical and/or electrical mechanism for depositing chemicals into a body of water.

In some examples, the device is not configured to float and is instead configured to be a part of a pool or hot tub assembly. All elements of the device may be included in this variation of the device except for the air pocket for floating. The device may be built into the side of the hot tub, pool, tank, or spa. The device may be built into a cover of a hot tub. The device may be built into the bottom surface of hot tub, pool, tank, or spa. The device may be removably attached to the hot tub, pool, tank, or spa. The device may be powered from the hot tub, pool, tank, or spa that it is installed within. The device may connect to a power supply or power control board internal to the hot tub, pool, tank, or spa.

Body of water may refer to any body of water housed within an object such as a hot tub, pool, tank, or spa.

In some examples. The housing may be rounded. The location of an air pocket may be within a rounded part of the housing that sits above the waterline.

In some examples, the device may comprise batteries or rechargeable batteries for powering the light emitters and/or mechanisms for dispensing of chemicals. In some examples, the device may comprise solar cells and be powered through solar power. In some examples. The device may be powered with AC or DC voltage. In some examples, the device may comprise disposable or rechargeable batteries or single battery. In some examples, the device may comprise of Peltier thermoelectric cells capable of producing power from the temperature delta between the device and the surrounding environment. The device may comprise internal wiring. The device may comprise a method for charging an internal battery such as removing the battery, access to a charging port within the device, wires exiting the device, or wireless charging capabilities. In some examples, the device may comprise a power supply or LED driver configured to convert input electrical power to the power required by the device. In some examples a DC to DC converter is required to convert power from a battery to the power required by the light emitters.

In some examples, the device comprises a controller configured to deposit the correct portion or concentration of chemicals in relation to the radiometric power of disinfecting light emitted into the body of water. In some examples, the higher radiometric power of disinfecting light emitted, the less chemicals are required. In some examples, the longer exposure time of disinfecting light to the body of water, the less frequently chemicals need to be deposited into the body of water. The controller may comprise a database of knowledge for the ratios of chemicals needed and disinfecting light needed to achieve a desired antimicrobial results within the body of water. The controller may additionally control the output of the disinfecting light from the device as well as the deposition of chemicals.

In some examples, the chemical deposition into the body of water can be characterized by the concentration of the chemical, the frequency of the deposition, and the amount of chemical deposited. Each of these characteristics may be controlled by the device.

In some examples, a controller may be on the same substrate as the light emitters, i.e., an on board controller. In some examples, a controller may be on a remote substrate from the light emitters.

In some examples, the device may comprise of or communicate with sensors. The sensors may be within the device or remote from the device.

In some examples, the device may comprise manual controls such as buttons or switches for controlling the device, such as controlling the disinfecting light output or the chemical deposition.

In some examples, the device may comprise visual user feedback such as indicator lights or graphical displays for controlling the disinfecting light output or the chemical deposition or monitoring the status of the disinfecting chemical cycle or disinfecting light cycle. The graphical displays may be LCD, OLED, or LED dot matrix.

In some examples, the device may be water sealed. The device may have an Ingress Protection (IP) rating of IP64, IP65, IP66, IP67, IP68, IP69, IP69K, etc. The device may comprise rubber gaskets for water sealing.

In some examples, the device may be protected against damage or malfunction due to impact. The device may have an impact rating of IK00, IK01, IK02, IK03, IK04, IK05, IK06, IK07, IK08, IK09, or IK10.

In some examples where the device is utilized in a hot tub, the device may turn off when the hot tub cover is removed from the hot tub and the hot tub is in use or open. This may be done to prevent insects from being attracted to the disinfecting light and entering the body of water through that light attraction. The device may turn off based on a proximity sensor. The proximity sensor may be laser-based Time-of-Flight or infrared. The device may turn off based on a light sensor, in some examples. The light sensor may determine if it is dark outside. There may be more bugs attracted to the light emitted from the device at night. In some examples, the device may turn off when it is night time and the hot tub cover is opened.

In some examples, portions of the housing may be transparent or translucent such that it allows light and/or disinfecting light to transmit through it.

In some examples, the device may comprise components, such as the housing, made from a plastic or polymer material. In some examples, portions of the housing may be opaque.

The device may have transparent or translucent lenses or windows embedded into it. In some examples, the device may comprise materials that reflect light within the range of 380-420 nanometers to enhance the disinfecting light output.

In some examples, the device may comprise features that allow it to be removably attached to surface, such as the side wall of a hot tub. Such features may include suction cups, magnets, snapping mechanisms, spring clip mechanisms, mating mounting bracket components, removable hardware, adhesives, mating materials such as hook and loop, etc.

In some examples the light emitters are disposed onto linear substrates. The linear substrates may protrude down below the waterline from the portion of the device that remains above the waterline. The linear substrates may be comprised within a cylindrical housing that protrudes below the waterline. The linear substrates may be positioned such that light radially emits from the cylindrical housing from various areas of the housing. There may be 1, 2, 4, 4, 5, 6, 7, 8, 9, 10, 11, 12 or more areas of the housing which emit light.

In some examples, the device may comprise an internal structure for holding other components of the device in place such as the light emitters or LED driver. The internal structure may be comprised of metal or plastic materials. In some examples, the internal structure is made of a metal material to aid in the heat sinking of the light emitters. The light emitters may be disposed on a substrate that is mounted against the internal structure.

In some examples, there may be an externally mounted heat sink. The externally mounted heatsink may be exposed to the body of water and pull heat from the device to the body of water. In some examples, the body of water may be a lower temperature than the device, substrate, or light emitter and therefore may help cool the device, substrate, or light emitter. The body of water may have a high heat capacity allowing it to pull heat from an externally mounted heat sink.

In some examples, the internal structure may comprise channels for mounting the substrates comprising the light emitters. In some examples, the internal structure may be an extruded profile. The internal structure may have a length within the range of 2 in to 24 in including any length in between such as 4 in, 6 in, 8 in, 10 in, 12 in, 14 in, 16 in, 18 in, 20 in, etc. In some examples, the internal structure may be a heat sink. The internal structure may comprise features for mounting other components such as substrates comprising light emitters. In some examples, the center of the internal structure is hollow to allow for components to be placed within or chemicals to pass through.

The device may comprise access doors for adding chemicals, accessing the batteries, etc., in some examples.

In some examples, there's an internal channel running from an access door within the housing above the waterline, to the portion of the device that deposits chemicals into the body of water. The portion of the device that deposits chemicals may be at the bottom of the device below the waterline. In some examples, the access door may be at the bottom of the device connected to the chemical deposition location below the waterline.

In some examples, a controller in communication with device or comprised within the device may control a characteristic of the emitted disinfecting light. A characteristic of the emitted disinfecting light may include one or more of the following: radiometric energy, color, color coordinates, color temperature, brightness, lumen output, mode of operation, which LEDs are powered on, wavelength range emitted, powered on, powered off, proportion of spectral energy within a wavelength range, etc.

In some examples, the device may emit different colors. The substrate may comprise light emitters that emit different colors. The substrate may comprise one or more channels of LEDs wherein each channel emits a different color light. The substrate may comprise RGB, RGBV, RGBW, RGBWW, or discrete red, blue, green, amber, cyan, violet, yellow, orange LEDs. Individual LEDs may emit different colors of light. The colors of light may be controlled by the device or a user may control the color output. LEDs may also emit white light. The white light may be CCT tunable and emit a CCT of 1800, 2200, 2700, 3000, 3500, 4000, 4500, 5000, 5700, 6000, or 6500K or tune the CCT to any value within the range of 1800 to 6500K. CCT stands for correlated color temperature.

In some examples, the disinfecting light may be emitted from the device in a disinfecting light cycle. The disinfecting light cycle may have an associated period of time. The disinfecting light cycle may turn on in a scheduled pattern for a certain number of hours. The disinfecting light cycle may occur when no humans are in the body of water. The disinfecting light cycle may occur when humans are in the body of water.

In some examples, the device may comprise a timer that powers off the emitting disinfecting light after a certain period of time. The certain period of time may be directly linked to a dosage requirement or power availability. In some examples, the period of time may be 4, 5, 6, 7, 8, 9, 10, 11, or 12 hours. The period of time may be linked to a cycle of operation of a hot tub, pool, or spa. The period of time may be linked to the usage patterns of the hot tub, pool, or spa.

The device may interface with a mobile device or mobile application. In some examples, the device may interface with a wireless network. The device may be compatible with controls that allow a user to remotely control the device. In some examples, the device may interface with controls directly within a hot tub, pool, or spa. The device may communicate light output characteristics to a user through a mobile device or application. In some examples, there is an indication that the disinfecting light cycle is over. The indication may include a notification on a mobile application, a message on the appliance, a sound, and/or a change in lighting from the device.

In some examples, the substrate may be circular in shape. In some examples, the substrate may be in the form of a circle with a hole in the middle. In some examples, the substrate may be linear or rectangular. The substrate may take any form factor to fit within the device.

In some examples, the substrate may be made of metal such as aluminum. The substrate may be made of plastic. The substrate may be made of FR4. The substrate may have an associated thickness.

In some examples the substrate may be installed against an internal surface of the device. In some examples, it may be installed against an internal structure or within a channel comprised within the device or the internal structure.

In some examples, the device may comprise of a substrate or circuit board with one or more light emitters disposed on it. In some examples, the light emitters may be LEDs. The circuit board may have 1 LED disposed on it. The circuit board may have 2 LEDs disposed on it. The circuit board may have 3, 4, 5, 6, 7, 8, 9 10, 11, 12, 13, 14, 15, 16, 17, 18, 19, 20, 21, 22, 23, or 24 LEDs disposed on it. The circuit board may have 12 or more LEDs disposed on it. In some examples, the circuit board may comprise a laser. The circuit board may be referred to as a substrate.

The device may cause microbial inactivation including viruses on surfaces or within air and water. The device may comprise microbial inactivation or disinfection over time. In some examples, higher irradiances are used over shorter periods of time. In some examples, lower irradiances are used over longer periods of time. A dosage may be comprised of an irradiance and exposure time. In some examples, the exposure time may be at least 1 hour. A target exposure time may be at least 4 hours, at least 6 hours, at least 8 hours, at least 10 hours, at least 12 hours, at least 24 hours, or at least 48 hours. In some examples, exposure may be continuous and not limited to a time period. In some examples, a target exposure time may be calculated continuously from measured usage.

In some examples, a dosage measured in J/cm² is targeted. A dosage may be used as a metric for determining an appropriate irradiance for microbial inactivation over a period of time. A target reduction in microorganism population(s) may be used (e.g., 1-Log₁₀ reduction, 2-Log₁₀ reduction, 99% reduction, or the like). In some examples a target dosage may be at least 20 J/cm². A target dosage may be between 10 and 100 J/cm². A target dosage may be more than 100 J/cm².

In some examples, the device may emit a minimum amount of radiometric energy measured from at least, greater than, less than, equal to, or any number in between about 10 mW and 100 W. The device may emit a radiometric energy sufficient to cause an irradiance on a surface a distance away. The radiometric energy may be sufficient enough to inactivate at least one microorganism's population and/or multiple microorganism populations. In some examples, a substrate may comprise multiple light emitters that emit a combined radiometric energy. A substrate may comprise multiple LEDs that emit a combined radiometric energy. In some examples, light emitters may emit a radiometric energy of at least 20 mW measured within the range of 380 to 420 nm. In some examples, light emitters may emit a minimum amount of radiometric energy measured from, at least, greater than, less than, equal to, or any number in between about 375 nm and 425 nm.

In some examples, the concentration of chemicals required for the sanitation or disinfection of a body of water is decreased by a percentage with the addition of visible light within the wavelength range of 380-420 nm transmitting into the body of water. The visible light may comprise an irradiance within the body of water that corresponds to the percent decrease in the required chemical concentration, such as chlorine or bromine based chemicals. In some examples the chemical concentration required may decrease by 5%, 10%, 15%, 20%, 25%, 30%, 35%, 40%, 45%, 50%, 55%, 60%, 65%, 70%, 75%, 80%, 85%, 90%, 95%, or 100%. In some examples the chemical concentration required may decrease at least by 5%, 10%, 15%, 20%, 25%, 30%, 35%, 40%, 45%, 50%, 55%, 60%, 65%, 70%, 75%, 80%, 85%, 90%, or 95%. In some examples, the chemical concentration be decrease by at least 12%.

In some examples, the chemical concentration required is based on a threshold percent kill required of microorganisms in the body of water. In some examples that threshold percent kill is 90%, 99%, 99.9%, or 99.99%.

Chemical concentration refers to the amount of a substance in a defined space. A solute is a substance dissolved in a solution. The concentration of a solution represents the mass of a solute per unit of volume. Parts per million (ppm) is a ratio that can be used to measure a chemical concentration. In a solution of water, a chemical concentration of 1 parts per million is a concentration of 1/1,000,000 of the solution. The conversion from 1 mg/L to 1 ppm is as follows:

$$\frac{1 mg}{1 L} \times \frac{1 g}{1000 mg} \times \frac{1 L}{1 , 000 mL} \times \frac{1 mL}{1 g} = \frac{1 g solute}{1 , 000 , 000 g solution} or 1 ppm \qquad Equation 3$$

1 ppm is equal to 1 mg/L with the assumption that the density of the solution is equivalent to water. In this case, 1 ppm is equivalent to 1 mg of solute per 1 liter of solution.

Frequency of deposition of chemicals refers to how often the chemicals need to be deposited into the body of water to maintain a threshold or target disinfection or sanitization percent kill within the body of water.

In some examples, the device may deposit chemicals at least once every 24 hours. In some examples, the device may deposit chemicals at least twice every 24 hours.

In some examples, the frequency of deposition of chemicals into the body of water required for sanitation or disinfection is decreased by a percentage with the addition of visible light within the wavelength range of 380-240 nm transmitting into the body of water. The visible light may comprise an irradiance within the body of water the corresponds to the percent decrease in the required frequency of chemical deposition, such as for chlorine or bromine based chemicals. In some examples the frequency of chemical deposition required may decrease by 5%, 10%, 15%, 20%, 25%, 30%, 35%, 40%, 45%, 50%, 55%, 60%, 65%, 70%, 75%, 80%, 85%, 90%, 95%, or 100%. In some examples the frequency of chemical deposition required may decrease at least by 5%, 10%, 15%, 20%, 25%, 30%, 35%, 40%, 45%, 50%, 55%, 60%, 65%, 70%, 75%, 80%, 85%, 90%, or 95%. In some examples, the frequency of chemical deposition may decrease by at least 12%.

An air-water interface may alter the path of light. In some examples, it is ideal to have light emitted below the surface of the water when the target for disinfection is the body of water in surfaces beneath the body of water. In some examples, it is ideal to have light emitted above the surface of the water when the target for disinfection is a surface above the waterline. The air-water interface may reflect light emitted from beneath the waterline back into the body of water when it reaches the air-water interface.

Light penetrates the waterline and changes direction depending on the angle of the light entering a source, which is known as refraction. The amount that the light will refract may depend on the speed as well as the angle of the light source. If light enters a body of water at a greater angle, then the amount of refraction will increase. If light enters a body of water at a 90° angle to the surface, the light will not change direction and the speed of the light entering the body of water will slow down. Angles of light are measured based on a “normal line” which is a line drawn at 90° to the surface of the medium. The refractive index is defined as the measure of change in the speed of light as it passes from one medium to another. When light transitions from air to a medium with a higher refractive index, such as water, it slows down and bends toward the normal line. When light transitions into a medium with a lower refractive index the light will speed up bending away from the normal line.⁵

TABLE 8

| | | Speed of light | Angle of refraction if |
|---|---|---|---|
| | Refractive | in substance | incident ray enters |
| Substance | index | (×1,000,000 m/s) | substance at 20° |
| Air | 1.00 | 300 | 20 |
| Water | 1.33 | 226 | 14.9 |
| Glass | 1.5 | 200 | 13.2 |
| Diamond | 2.4 | 125 | 8.2 |

Determining the irradiance within a body of water may be complex as there are infinite points within the volumetric space of the body of water an irradiance may be measured at. Irradiance measurements may need to be taken with a spherical measurement probe for taking in light from all directions around the spherical measurement probe at the location within the body of water a measurement is desired at. An average irradiance within the body of water may be used. The average irradiance may comprise of an average of multiple irradiance measurements taken within the body of water.

In some examples, there may be a cylindrical component protruding down from the floating device into the body of water. The cylindrical component may comprise linear lenses running vertically down the cylindrical component that allow disinfecting light to transmit out of the device into the body of water. There may be 1, 2, 3, 4, 5, 6, 7, 8, 9, 10, 11, or 12 lenses. In between each lens a there may be a vertical dispense point for chemicals to be deposited into the body of water. The vertical dispense point may comprise vents or baffles the chemicals to exit the device. The cylindrical component may be submerged in water. In some examples, behind each lens is a sealed housing comprising a light emitter. The sealed housing prevents water from contacting the light emitter.

In some examples the device may be compatible with chemical tablets such as chlorine or bromine based compounds in tablet form. In some examples the device may be compatible with powder based chemicals. In some examples, the device may be compatible with liquid based chemicals. In some examples, the concentration of the chemicals may correspond a target concentration required when the chemicals are used in conjunction with disinfecting light to disinfect or sanitize a body of water.

In some examples the device may comprise a chemical injection point for injecting liquid chemicals into the water. The injection may be caused by an electrical and/or mechanical mechanism. The frequency or concentration of chemicals may be based on an irradiance of disinfecting light received in the body of water. The mechanism for depositing the chemicals may be a pump.

In some examples the chemical deposit point of the device may comprise baffles that may automatically open and close to control the amount of chemicals deposited into the body of water. A controller integrated into the device may control the opening and closing of the baffles. All of the baffles may be open or closed. In some examples, a portion of the baffles may close or open to control the amount of chemicals deposited. The amount of chemicals deposited may correspond to a radiometric output of disinfecting light emitted from the device or an irradiance received within the body of water of the disinfecting light. The opening and closing of baffles may control a frequency or concentration of the chemicals deposited into the body of water. In some examples the baffles or openings for chemical deposition may be manually opened or closed via a mechanism for covering the openings or baffles accessible by a user of the device.

In some examples the device may comprise sensors that monitor characteristics of the water. The sensors may detect pH, temperature, oxidation-reduction potential (ORP), chemicals levels, alkalinity, stabilizers, cyanuric acid, irradiation, bioburden and/or calcium hardness. The sensors may communicate with a gateway that provides the information to a phone application for the user to monitor. The sensors may be in communication with a controller that may control the output of disinfecting light and chemical deposition coming from the device. The sensor data may provide inputs for the controller to adjust the disinfecting light output or the chemical concentration or frequency of deposition.

In some examples, there may be a remote underwater sensor in communication with the device. The remote sensor may be configured to stay underneath the body of water and/or travel within the body of water. The remote sensor may float on the waterline and comprise the sensor measurements points below the waterline to measure characteristics of the water. In some examples, the sensor may have sensor measurement points above the water line for measuring characteristics of the air. The remote sensor may detect irradiance of disinfecting light and/or bioburden in the body of water. The remote sensor may provide data to a controller within the device to inform the control of disinfecting light emission and/or chemical deposition from the device into the body of water.

In some examples, a photocatalyst is an additional layer or element of the device, apparatus, or system.

In some examples, a photocatalyst is not used in the device, apparatus, or system.

In some examples, the light emitters emit light in the ultraviolet wavelength range.

In some examples, the light emitters emit light with a peak wavelength in the ultraviolet wavelength range.

In some examples, the light emitters do not emit light in the ultraviolet wavelength range.

In some examples, the light emitters emit light with a peak wavelength that is not in the ultraviolet wavelength range.

In some examples, the light emitters are LEDs.

In some examples, visible light and chemicals are used in conjunction to provide disinfection or sanitization to bodies of water.

In some examples, visible light within the range of 380-420 nm is used in conjunction with chemicals to provide disinfection or sanitization to bodies of water.

In some examples, chemicals applied to bodies of water may include chlorine, bromine, sodium hypochlorite, sodium monopersulfate, cyanuric acid, pH balancers, baking soda, sodium carbonate, muriatic acid, sodium bisulfate, calcium chloride, algaecide, clarifier, ammonium chloride, flocculant, isopropyl alcohol, quaternary ammonium compounds, alkylbenzyldimethyl, chlorides, trichloroisocyanuric acid, copper sulfate pentahydrate, ammonia, copper sulfate, lanthanum chloride, calcium hydroxide, hypochlorous acid, calcium salt, sodium hydroxide, sodium salt, dihydrate, aluminum sulphate, boric acid, potassium peroxymonosulfate sulfate, sodium bicarbonate, sodium dichloroisocyanurate, sodium tetraborate pentahydrate, sodium peroxymonosulfate, benzalkonium chloride, trichloro-S-triazinetrione, chlorinated compounds, bromine-containing compounds, and hypobromous acid.

In some examples, the device may inactivate microorganisms within a body of water.

In some examples, the device reduces the effort required by humans in maintaining the sanitation of a body of water, such as a pool or hot tub.

In some examples, the device reduces the concentration and/or frequency of chemicals required to sanitize a body of water.

In some examples, a method for disinfecting a body of water may be employed comprising detecting a microbial characteristic of a body of water via a sensor and comparing the microbial characteristic to a target threshold. Wherein upon determining the microbial characteristic is below the target threshold, the method further comprises outputting, via a light emitter in a device, a disinfecting light comprising a wavelength range of 380-420 nanometers (nm) into the body of water and depositing, via a mechanism in a device, a chemical into the body of water at a determined concentration and frequency.

In some examples, a device for disinfecting a body of water may be employed comprising a housing configured to float at the surface of a body of water, wherein a portion of the housing is above the surface of the body of water and a portion of the housing is below the surface of the body of water, a light emitter disposed within the housing below the surface of the body of water and configured to emit light within the wavelength range of 380 to 420 nanometers (nm) at a determined radiometric power into the body of water, and a mechanism disposed within the housing below the surface of the body of water and configured to deposit chemicals at a determined concentration and frequency into the body of water.

In some examples, the device may prevent biofilm formation.

In some examples, the device may help alleviate problems chlorine intolerance in bacteria within bodies of water the device is disposed within.

In some examples, the device may emit ultraviolet radiation with a wavelength within the range of 100-400 nanometers.

In some examples, a chlorine concentration deposited within a body of water, such as a pool, may be 4 mg/L. In some examples, emitting disinfecting light from the device may reduce the required chlorine concentration to less than 4 mg/L.

In some examples, a free chlorine concentration within a body of water, such as a pool, may be at least 1 mg/L, at least 2 mg/L or at least 3 mg/L. In some examples, emitting disinfecting light from the device may reduce the required free chlorine concentration to less than 3 mg/L, less than 2 mg/L or less than 1 mg/L.

In some examples, a bromine concentration deposited within a body of water, such as a hot tub, may be at least 3-4 mg/L or at least 4-6 mg/L. In some examples, emitting disinfecting light from the device may reduce the required bromine concentration to less than 6 mg/L, less than 5 mg/L, less than 4 mg/L, or less than 3 mg/L.

In some examples, multiple devices may be used within one body of water to increase coverage of the disinfecting light emitted from the device.

In some examples, the device may be made of a material that resists degradation from sunlight.

In some examples, the device may be made from a material that resists degradation from chemicals such as chlorine or bromine based chemicals.

In some examples, the device runs automatically without the intervention of humans.

In some examples, the device requires recharging.

In some examples, the device requires a human to add more chemicals.

In some examples, the light emitted in a direct line out of the light emitter does not pass through an air-water interface.

In some examples, an average irradiance is targeted within at least a portion of the total volume of water within the total body of water.

In some examples, the device only targets a portion of the body of the volume of water within the total body of water at a time. The device may move on the surface of the water to target different portions of the body of water. A time period may be required before the device has targeted the total body of water. Only a portion of the body of water may be targeted at a time. Each portion may be targeted for a period of time then the device may move on to the next portion.

In some examples, the movement of the device is determined by the water flow and currents. In some examples, the body of water may create specific water flow and currents to direct the device around the body of water to ensure all parts of the body of water are targeted.

In some examples, the device may comprise a propulsion and steering element that allows it to travel along the waterline in a desired pattern for providing disinfecting light to all portions of the body of water.

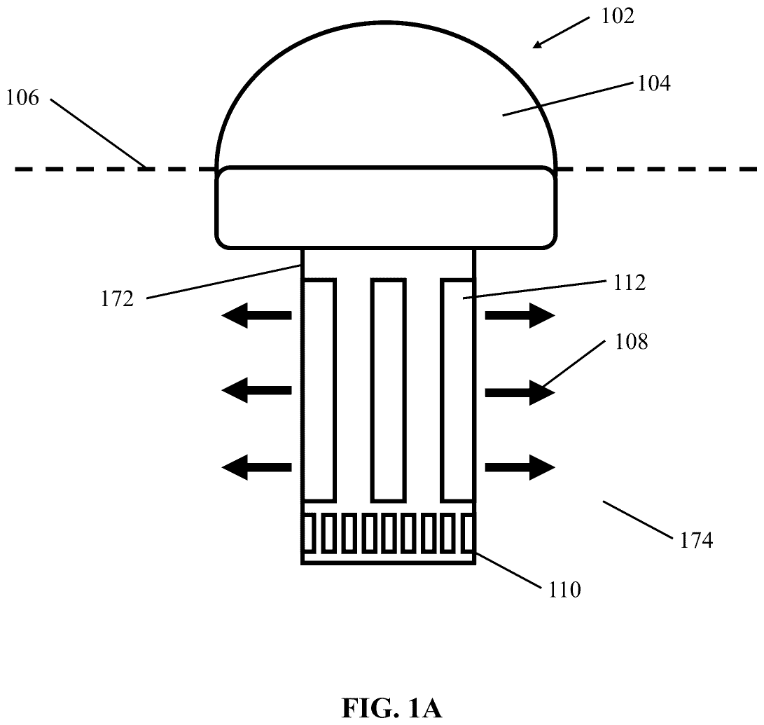

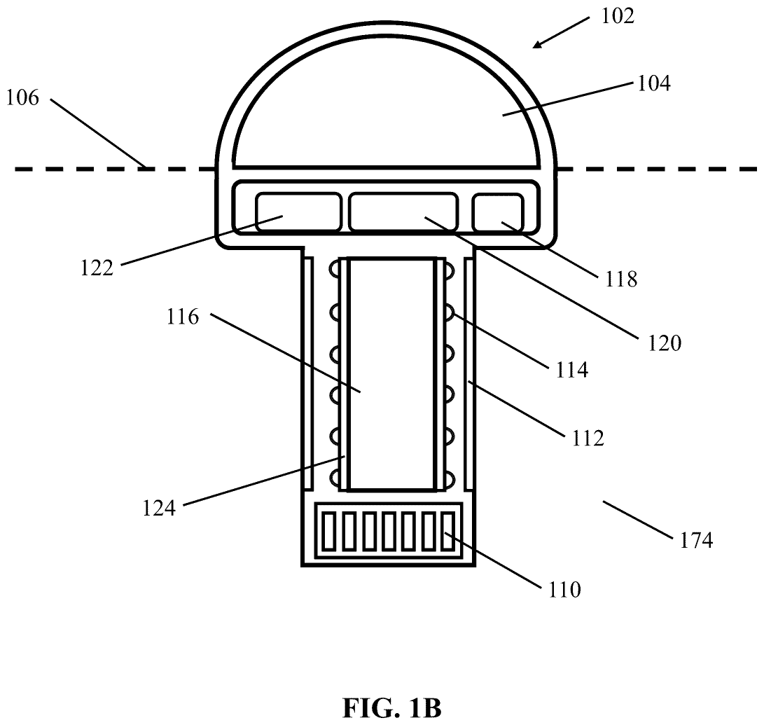

FIG. 1A depicts an example device 102 that floats on the water line 106 and has a portion of the housing protruding in a cylindrical shape below the water line 172. There may be lenses 112 running vertically down the cylindrical shape. There may be ventilation or baffles at the bottom of the device for depositing chemicals.

FIG. 1B depicts a cross sectional view of FIG. 1A. Air or foam pocket 104 may allow for device 102 to float on the water line 106. Light emitters 114 are configured to emit disinfecting light 108 and positioned behind the lenses. There may be 1, 2, 3, 4, 5, 6, 7, 8, 9, or 10 lenses. Light may be emitted 360 degrees around the central axis of the vertical protruding cylindrical shape.

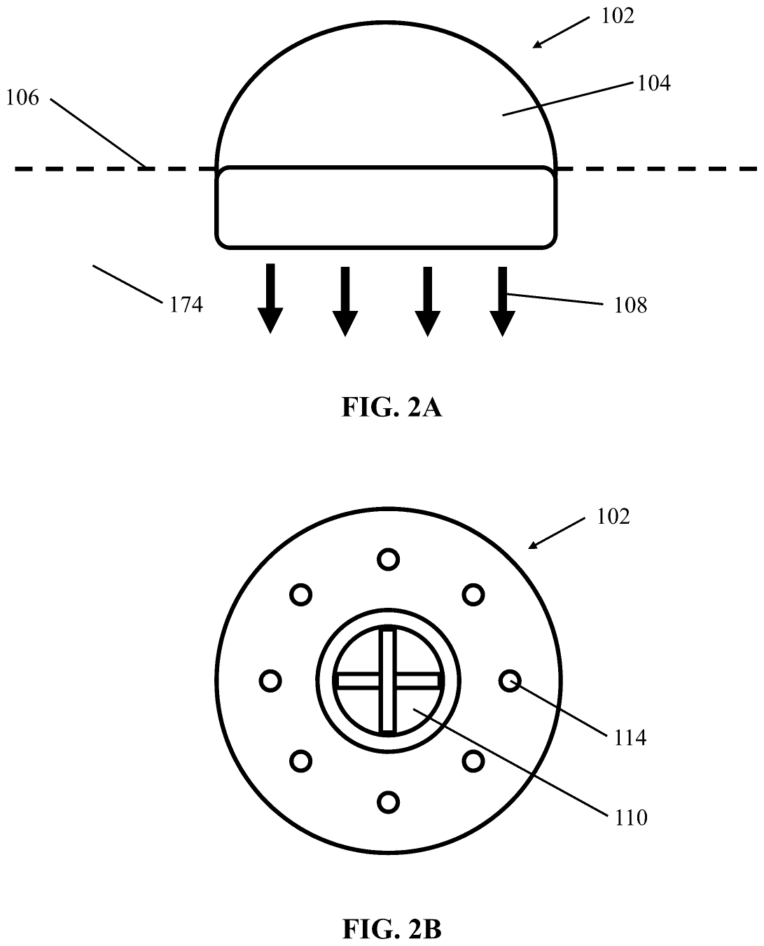

FIGS. 2A and 2B depict an example device 102 wherein the disinfecting light 108 is emitted straight down into the body of water 174. The light emitters 114 may be positioned in the device below the waterline 106. The light emitters 114 may be positioned in a circular ring shape that allows for a central location within the bottom of the device for depositing chemicals 110. The device may float due to air or foam pocket 104.

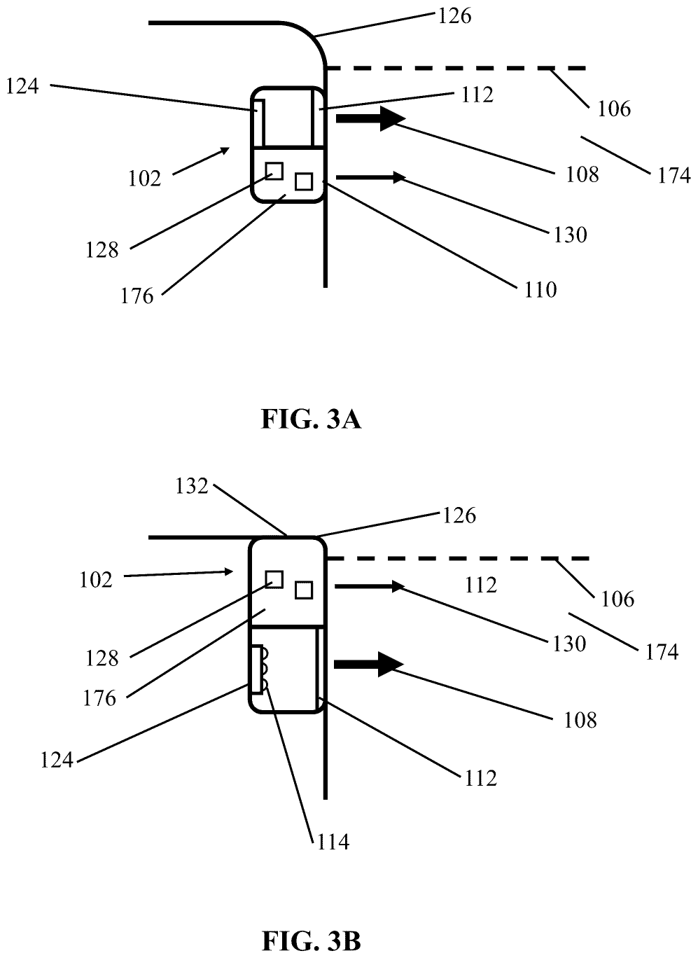

FIGS. 3A and 3B depict an example device wherein the device is integrated into the side of a pool or hot tub 126. FIG. 3A depicts example device 102 beneath the water line 106. FIG. 3B depicts example device 102 partially above and partially below the water line 106. The device may comprise an area for housing elements that emit disinfecting light such as substrate 124 with disposed light emitters 114. In some examples, the device may comprise an area for housing elements that deposit chemicals 128 into the body of water and a storage area for chemicals 176. In some examples, the chemical deposition and chemical storage area 176 is both above and below the waterline 106 such that the chemicals 128 can be added above the waterline 106 and deposited from the chemical deposition point 110 into the body of water 174 below the waterline.

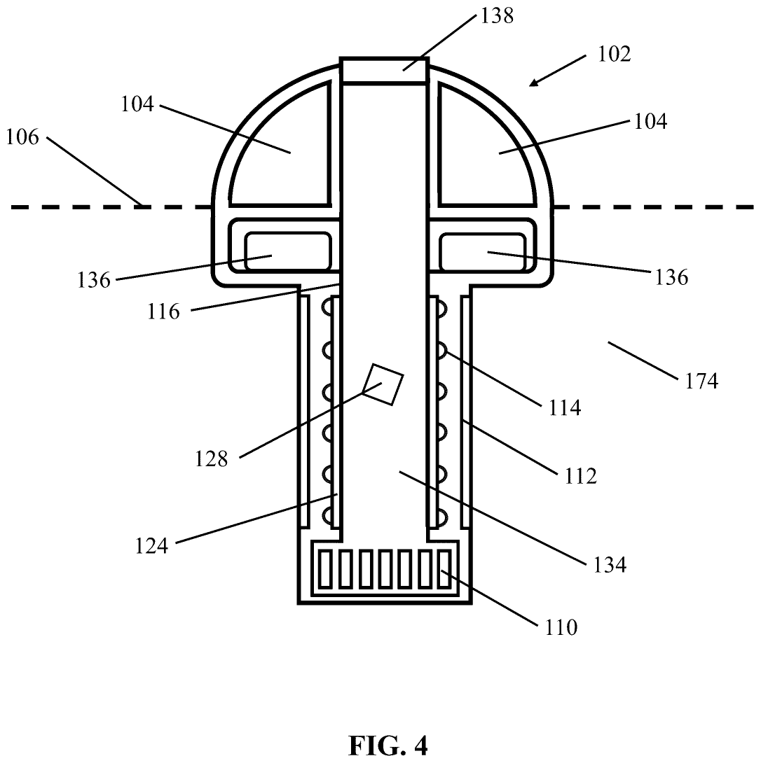

FIG. 4 depicts a cross sectional view of an example device 102 wherein an internal channel 134 is used to add chemicals 128 to the device through an access door 138. The chemicals may be in tablet form in some examples. There may be areas within the device for housing electrical components 136 such as a controller or power supply. The device 102 may comprise a substrate 124 disposed with light emitters 114 that emit disinfecting light into the body of water 174. Chemicals 128 may be deposited into the body of water 174 through chemical deposition point 110.

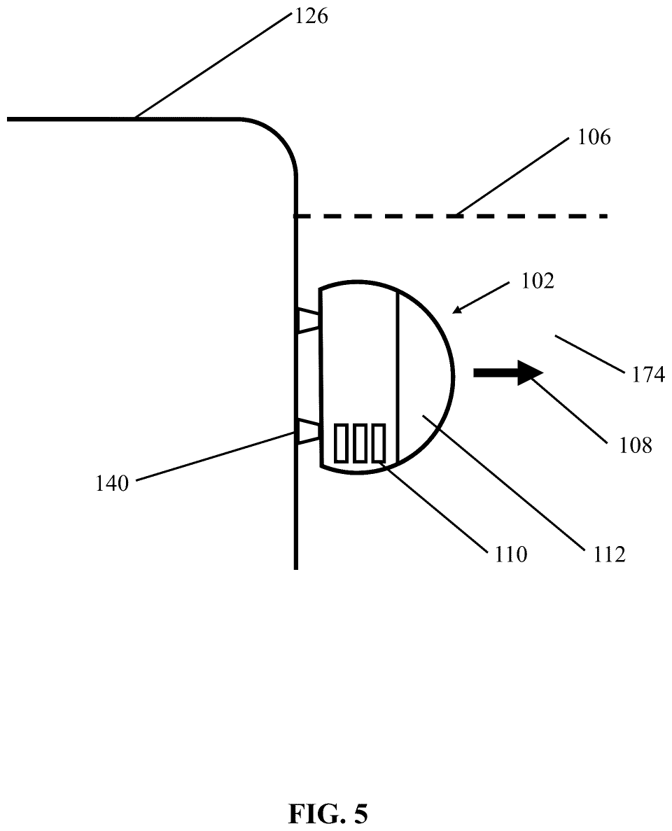

FIG. 5 depicts an example device 102 wherein the device is removably attached to a surface 126 beneath the water line 106, such as the side of a pool or hot tub via mounting mechanism 140. The device may emit disinfecting light 108 and comprise a mechanism for depositing chemicals into the body of water 174 though chemical deposition point 110.

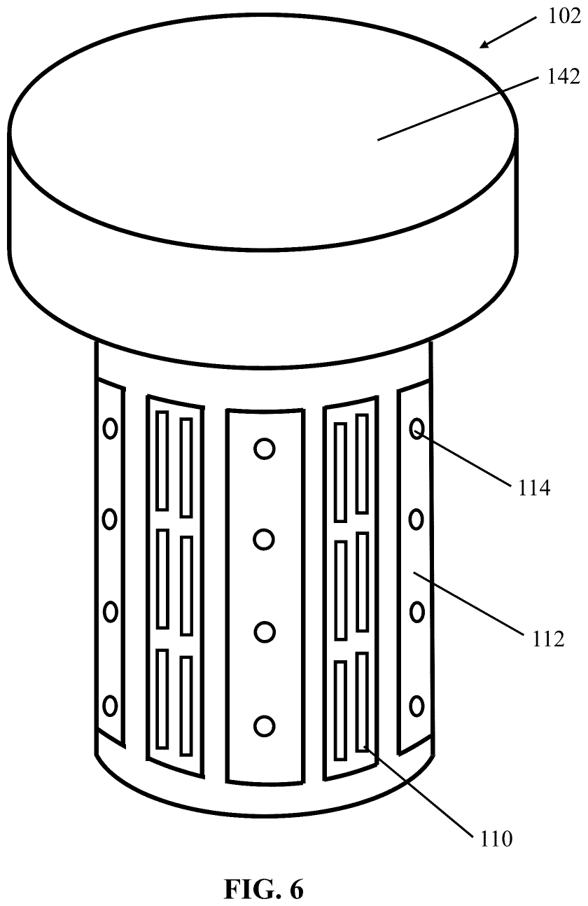

FIG. 6 depicts an example device 102 wherein vertical chemical deposit areas 110 are used. The chemical deposit areas 110 may comprise vents or baffles and be linear and run parallel to the lenses 112. Light emitters 114 may be positioned behind the transparent or translucent lenses. The vertical linear chemical deposit areas may connect to a central location inside the device that contains the chemicals to be deposited from chemical deposition points 110.

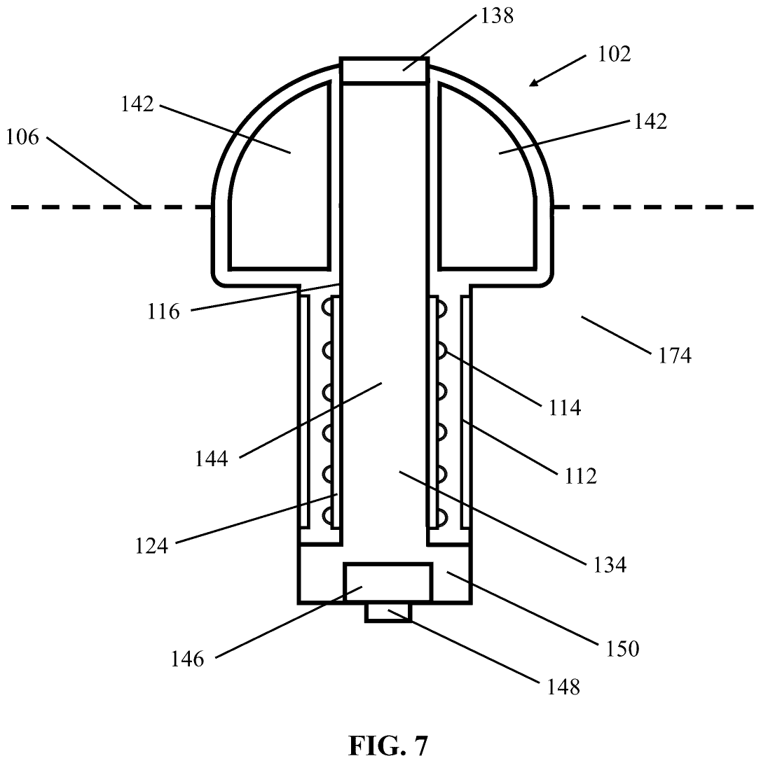

FIG. 7 depicts a cross sectional view of an example device 102 that comprises a chemical injection point 148 at the bottom of the device for injection liquid chemicals into the body of water 174. This device additionally comprises light emitters 114 for emitting disinfecting light, in some examples. In some examples, an access door 138 is positioned at the top of the device for adding chemicals into the device to be deposited by the device into the body of water 174 through a mechanism for injecting liquid chemicals 146. The liquid chemicals may travel from access door 138, through the channel for transporting chemicals 144, to the mechanism for injecting liquid chemicals 146, and out through the injection point 148. Chemicals may be stored in channel 144.

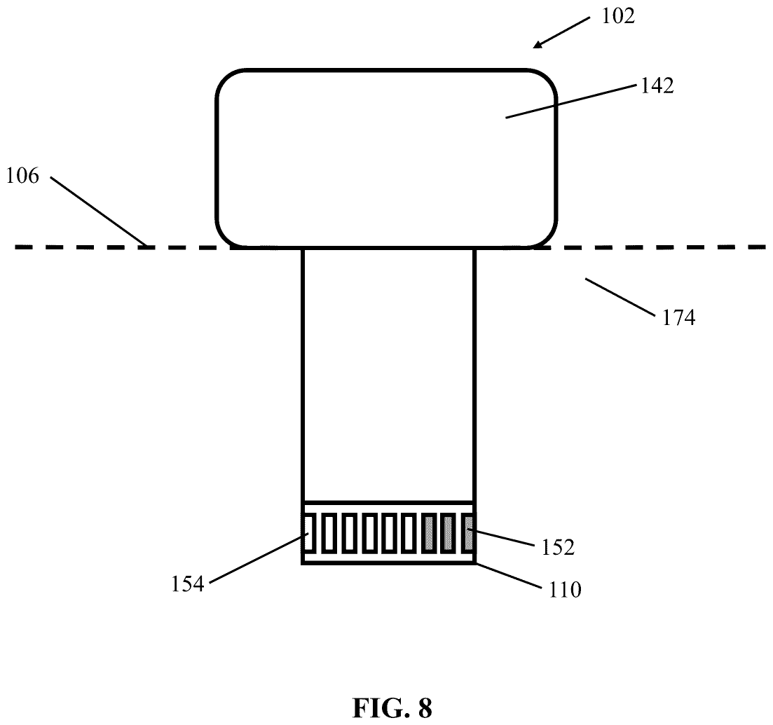

FIG. 8 depicts an example device 102 using baffles on the chemical deposition point 110 such that the baffles open and close to control the amount of chemicals deposited into the body of water 174. The baffles 152 may be closed or the baffles 154 may be open. The baffles may automatically open and close or may be manipulated by the user. The baffles may control the frequency or concentration of chemicals deposited into the body of water 174. The chemical deposition point 110 may be below the waterline 106. The device 102 may comprise an internal space for holding components 142.

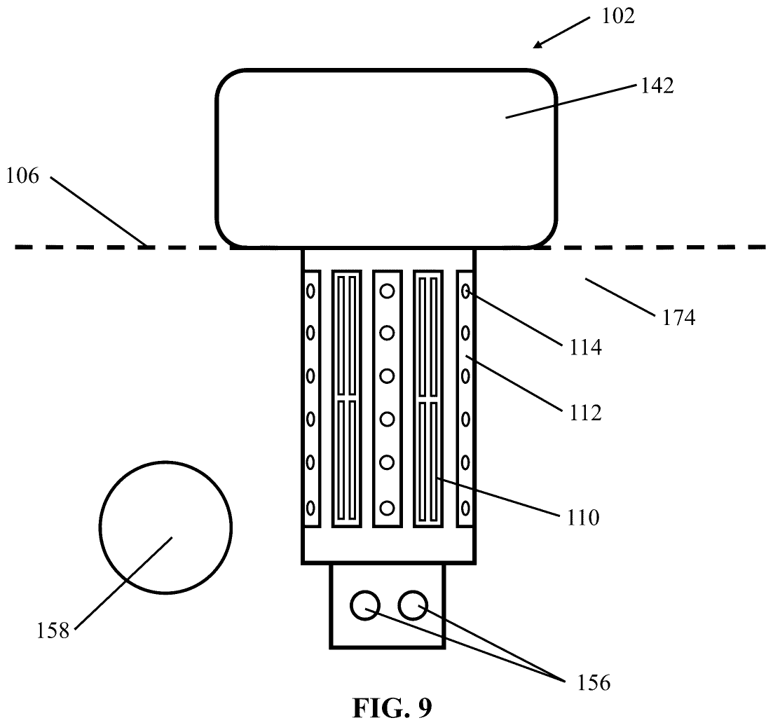

FIG. 9 depicts an example device 102 that comprises sensors 156 on the device. In some examples, a remote sensor 158 may be in communication with the device 102. The remote sensor 158 may remain under waterline 106 or float on the waterline 106. The example device may comprise lenses 112 with light emitters 114 disposed behind the transparent or translucent lens 112. The example device 102 may comprise chemical deposition points 110 located radially around the device. Device 102 may additionally comprise an internal space for holding components 142 which may hold electrical components in communication with the sensor(s) 156 and/or the remote sensor(s) 158.

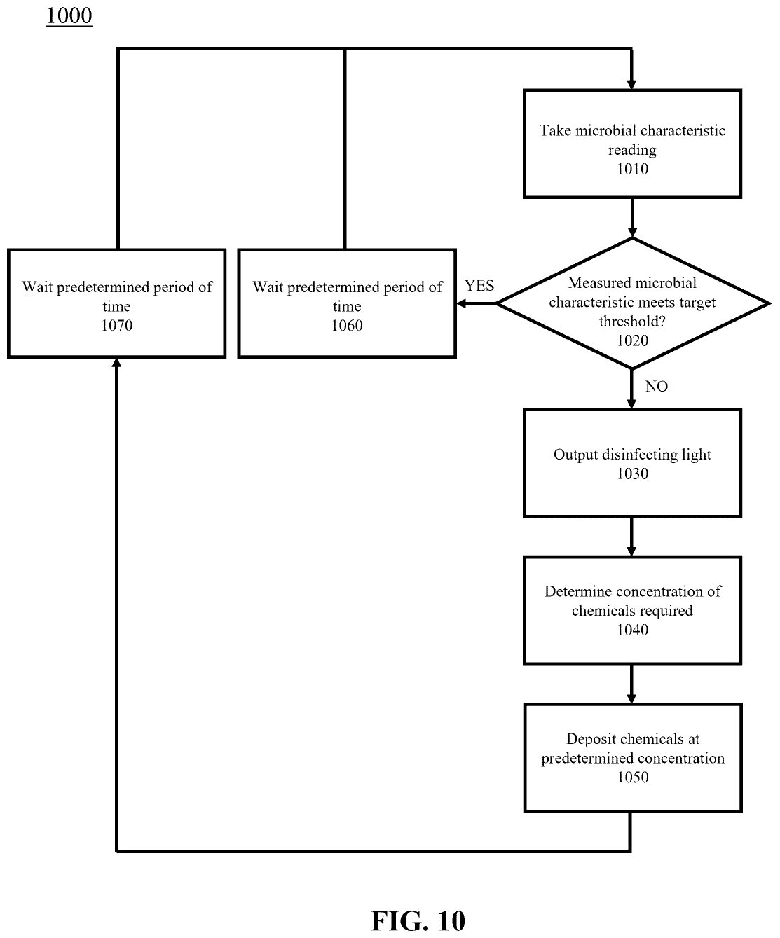

FIG. 10 depicts process 1000 via a flow chart wherein a microbial characteristic reading is taken via step 1010 within a body of water from a sensor in communication with the device. The device may comprise the sensor or the sensor may be remote from the device. The controller then determines if the measured microbial characteristic meets a target threshold via step 1020. If the target threshold is met, the device waits a predetermined period of time via step 1060 before repeating the process starting with step 1010 the measurement of the microbial characteristic. If the target threshold is not met, the device will output disinfecting light via step 1030. Then, the device will determine the concentration of chemicals required via step 1040. In some examples, the concentration of chemicals is predetermined by the controller or by the user when inputting chemicals into the device. Next, the device will deposit the chemicals into the body of water via step 1050. The device will then wait a different predetermined amount of time via step 1070 before repeating the process starting with step 1010.

The microbial characteristic may be a level of chemicals in the body of water which relates to a recommended threshold or target level of chemicals for providing disinfection or sanitization to the body of water. If the chemical levels are below the target threshold, then the microbial characteristic measured is below the target threshold.

The microbial characteristic may be an irradiance of disinfecting light comprising a wavelength range of 380-420 nm received at the sensor.

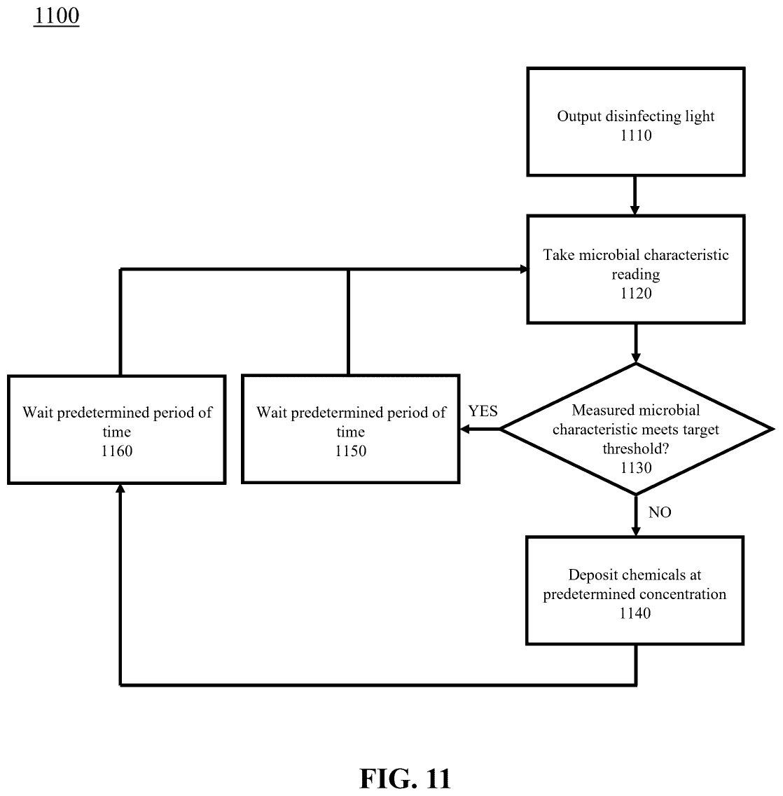

FIG. 11 depicts process 1100 via a flow chart wherein disinfecting light is continuously output by the device into a body of water via step 1110. The device then takes a microbial characteristic measurement using a sensor via step 1120. The controller then determines if the measured microbial characteristic meets a target threshold via step 1130. If the target threshold is met, the device waits a predetermined period of time via step 1150 before repeating the process starting with step 1120 the measurement of the microbial characteristic. If the target threshold is not met, the device will deposit chemicals into the body of water via step 1140. The device will then wait a different predetermined amount of time via step 1160 before repeating the process starting with step 1120.

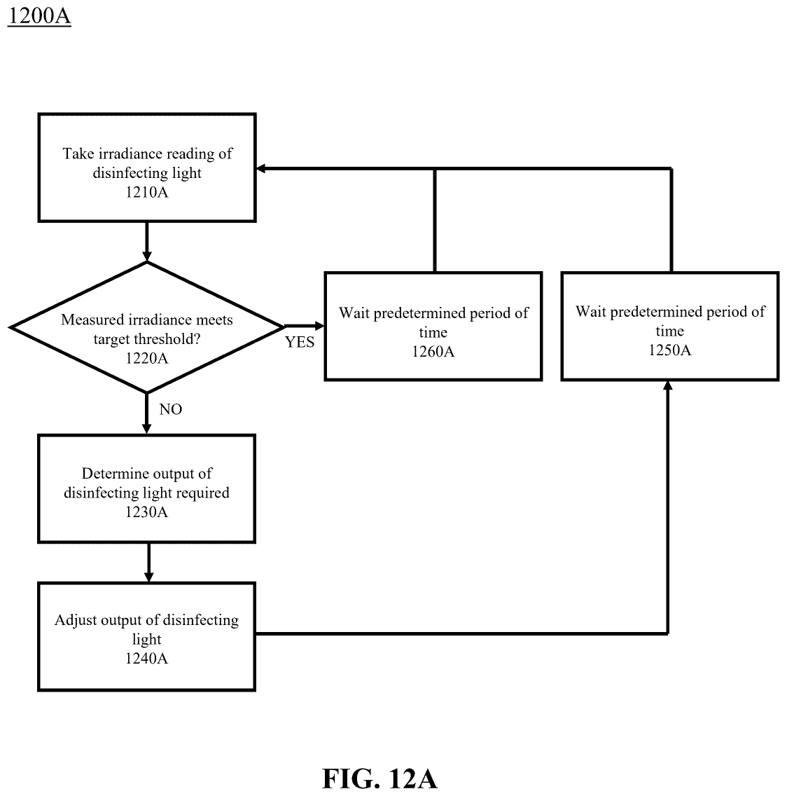

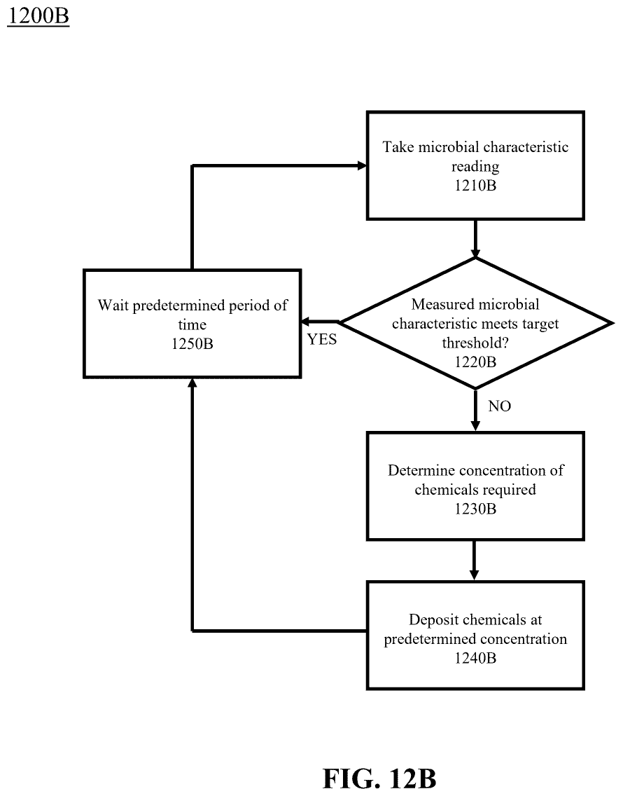

FIG. 12A depicts process 1200A via a flow chart wherein an irradiance measurement is taken within the body of water by an irradiance sensor via step 1210A. The irradiance sensor may be remote from the device or may be comprised within the device. The controller then determined if the measure irradiance meets a target threshold vis step 1220A. If the target threshold is met, the device will wait a predetermined period of time via step 1260A before repeating the process starting with step 1210A. If the target threshold is not met, the device will determine the output of disinfecting light required via step 1230A. The device will then adjust the output of the disinfecting light via step 1240A. The device will then wait a different predetermined amount of time via step 1250A before repeating the process starting with step 1210A.

FIG. 12B depicts process 1200B via a flow chart wherein a microbial characteristic is measured within the body of water via step 1210B from a sensor in communication with the device. The controller then determines if the measured microbial characteristic meets a target threshold via step 1220B. If the target threshold is met, the device waits a predetermined period of time via step 1250B before repeating the process starting with the measurement of the microbial characteristic via step 1210B. If the target threshold is not met, the device will determine the concentration of chemicals required via step 1230B. Next, the device will deposit the chemicals into the body of water via step 1240B. The device will then wait a different predetermined amount of time via step 1250B before repeating the process starting with step 1210B.

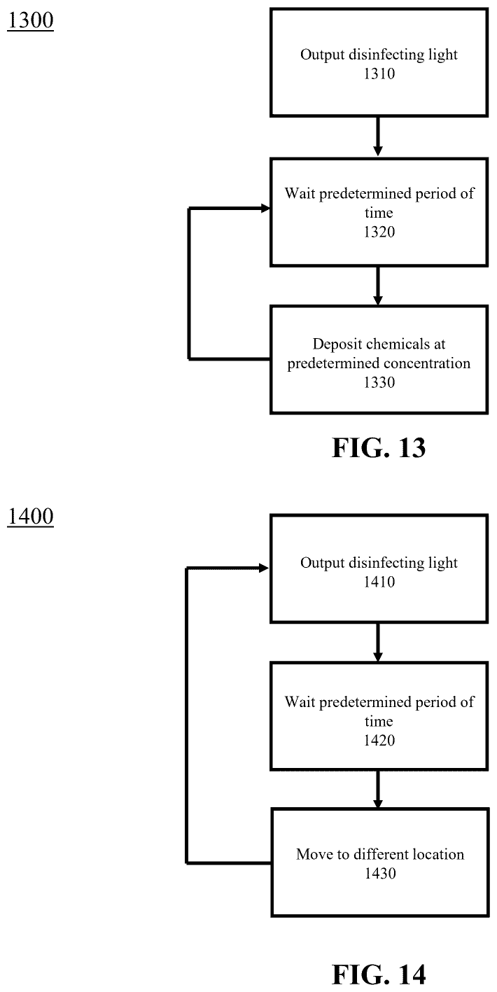

FIG. 13 depicts process 1300 via a flow chart wherein disinfecting light is output into a body of water continuously via step 1310. The device then waits a predetermined period of time via step 1320 before depositing chemicals into the body of water at a predetermined concentration via step 1330. The device then waits a predetermined period of time via step 1320 before depositing chemicals again via step 1330.

FIG. 14 depicts process 1400 via a flow chart wherein disinfecting light is output via step 1410 at a specific location for a predetermined period of time which it waits for via step 1420, before the device moves to the next location via step 1430 to output the disinfecting light for a predetermined period of time in a different location.

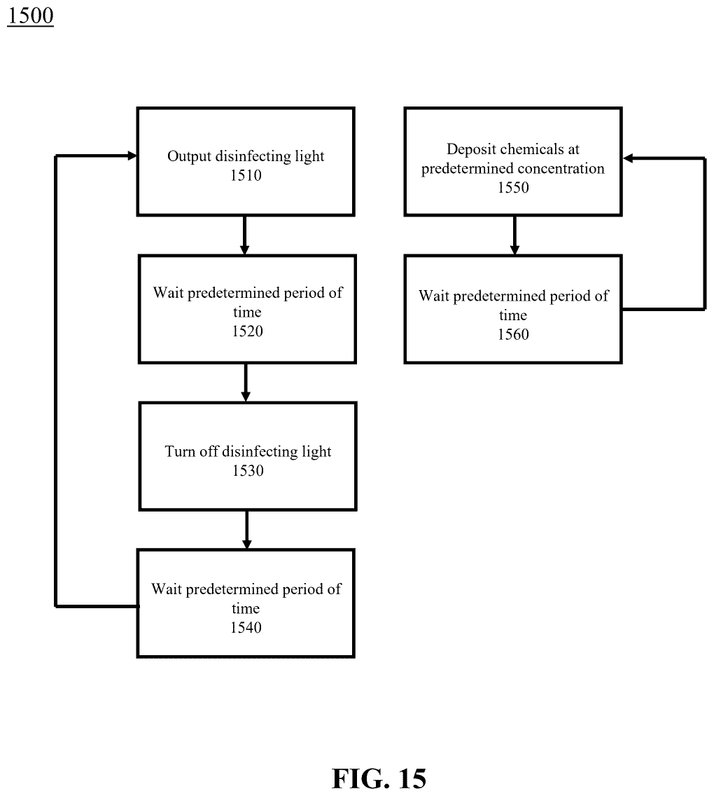

FIG. 15 depicts process 1500 via two parallel flow chart pathways wherein the first outputs disinfecting light into a body of water via step 1510, waits a predetermined period of time via step 1520, turns off the disinfecting light via step 1530, and then waits another predetermined period of time via step 1540 before repeating. The second deposits chemicals at a predetermined concentration via step 1550 into a body of water, then waits a predetermined period of time via step 1560 before repeating the process.

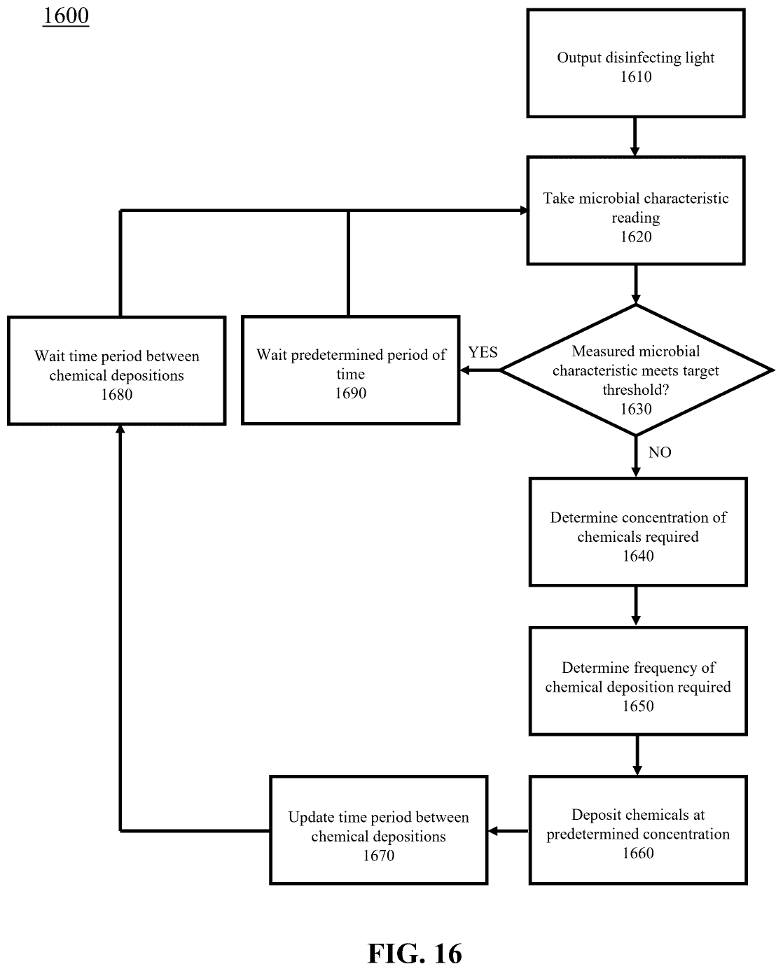

FIG. 16 depicts process 1600 via a flow chart wherein disinfecting light is continuously output into a body of water via step 1610. The device then takes a microbial characteristic measurement using a sensor via step 1620. The controller then determines if the measured microbial characteristic meets a target threshold via step 1630. If the target threshold is met, the device waits a predetermined period of time via step 1690 before repeating the process starting with the measurement of the microbial characteristic 1620. If the target threshold is not met, the device will determine the concentration of chemicals required via step 1640 and then determine the frequency of chemical deposition required via step 1650. Next, the device will deposit the chemicals into the body of water via step 1660. Next, the device will update the time period between chemical depositions based on the determined frequency, if there was a change via step 1670. The device will then wait a different predetermined amount of time via step 1680 before repeating the process starting with step 1620.

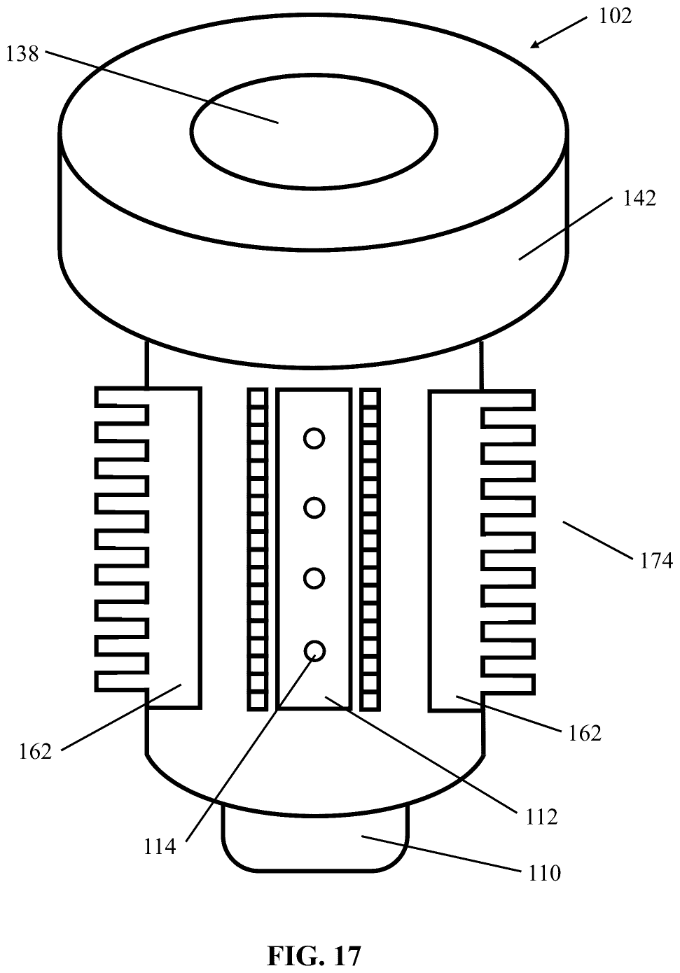

FIG. 17 depicts an example device 102 wherein heat sinks 162 protrude from the device to allow for heat to dissipate into the body of water 174. The portion of the heat sink internal to the device may be disposed with a substrate and light emitter 114 that produces heat. The heat may travel through the heat sink 162 to the outside of the device and dissipate into the body of water 174. The heatsink 162 may protrude from the device on either side of a lens 112, in some examples. The heat sink 162 may be produced through sheet metal machining and may comprise fins that are external to the device 102.

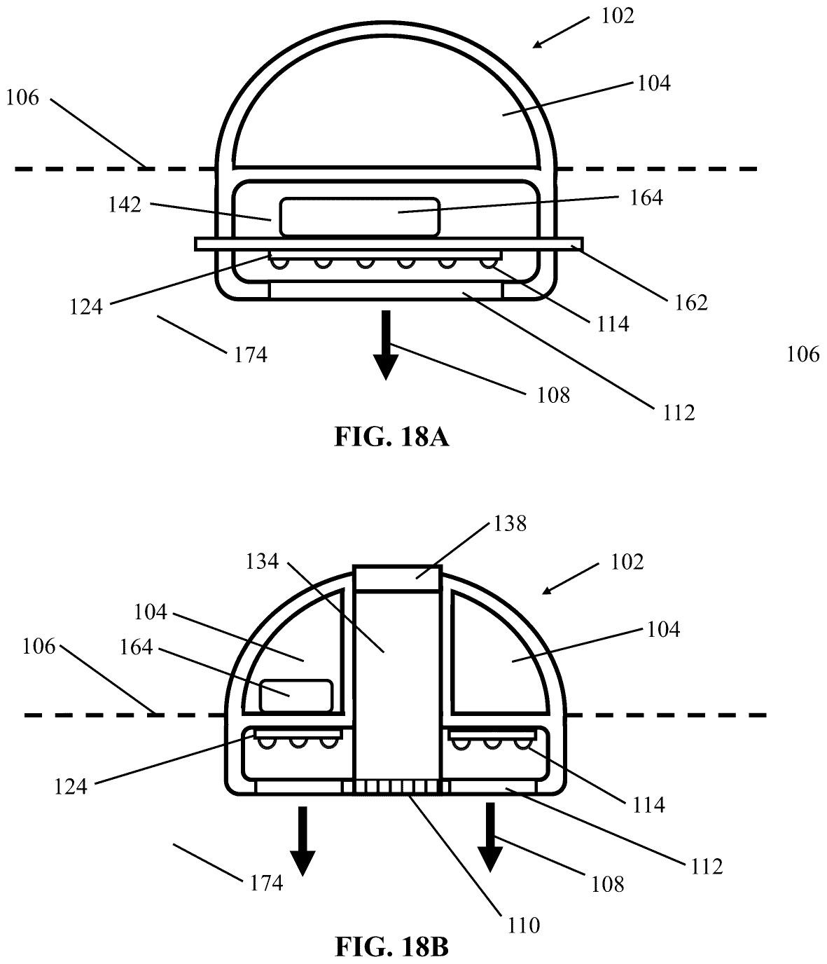

FIG. 18A depicts an example device 102 comprising a heat sink 162 that a substrate 124 may be mounted to. The heat sink 162 may be a flat disc that protrudes externally from the device 102 into the body of water 174. The edges of the disc external to the device may contact the body of water 174 and dissipate heat into the body of water 174. The substrate 124 by be in direct contact with heat sink 162. The substrate may be disposed with one or more light emitters 114. The light emitters may emit disinfecting light 108 through lens 112 and into body of water 174. The substrate 124 may be below waterline 106. The device may comprise an air or foam pocket 104 for allowing the device to float on waterline 106. The device may additionally comprise an internal space for holding components 142 wherein electrical components 164 may be disposed.

FIG. 18B depicts an example device 102 further comprising an internal channel 134 for chemicals. The chemicals may enter the device through access door 138, pass through or be stored within channel 134, and exit the device through chemical deposition point 110. A ring shaped substrate 124 may surround the central channel 134. The substrate may be disposed with one or more light emitters 114. The light emitters may emit disinfecting light 108 through lens 112 and into body of water 174. The substrate 124 may be below waterline 106. The device may comprise an air or foam pocket 104 for allowing the device to float on waterline 106. The device may additionally comprise an internal space wherein electrical components 164 may be disposed.

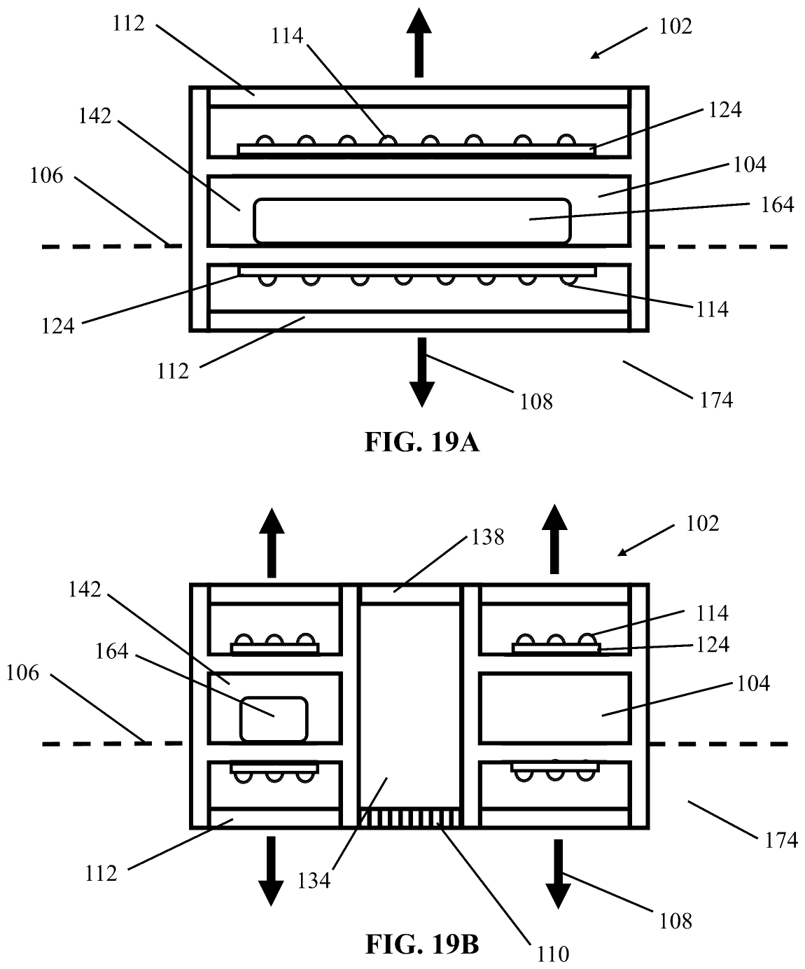

FIG. 19A depicts an example device 102 wherein light emitters 114 are directing light up out of the device 102 and down out of the device 102 through lenses 112. The disinfecting light 108 emitted up is above the waterline 106 and targeting a surface above the waterline. The disinfecting light 108 emitted down is below the waterline 106 and is targeting the body of water 174 or a surface underneath the waterline 106 touched by the body of water 174. The device may comprise a substrate 124 facing at the top of the device disposed with light emitters 114 and a substrate 124 facing down at the bottom of the device disposed with light emitters 114. The device may comprise electrical components 164 within an internal space for holding components 142.

FIG. 19B depicts an example version of the device 102 in 19A wherein there is a central channel 134 for depositing chemicals and a chemical deposit point 110 at the bottom of the channel and an access door 138 at the top of the channel. The lenses 112 and substrate 124 may be shaped as a circle with a hole in the middle or a ring shape allowing for the central channel 134 to run therethrough. The air pocket 104 may also be in the volumetric shape of a donut. The air pocket 104 and the internal space for holding components 142 may be one in the same.

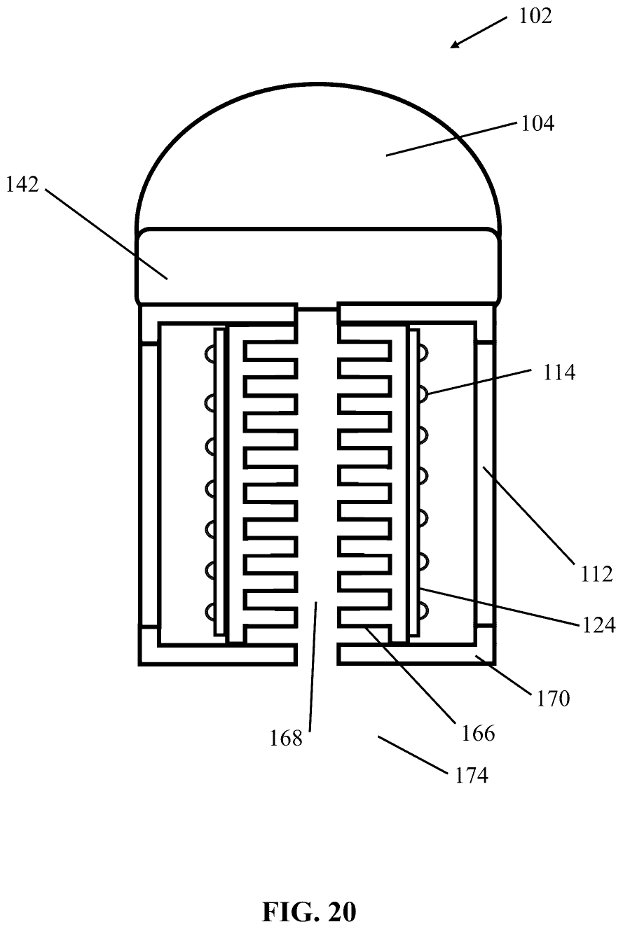

FIG. 20 depicts an example device 102 with a central hollow heatsink tube 166 with internal fins that are open to the water within channel 168. The water may enter the internal channel 168 of the heatsink and allow heat to dissipate from the heatsink 166 to the body of water 174. The opposite side of heatsink may comprise a substrate 124 with LEDs or light emitters 114 that produce heat directly mounted to it. The light may pass through lens 112 into the body of water 174. The device may comprise an air or foam pocket 104 and an internal area for holding components 142.

In some examples, the device may emit light that creates an irradiance within water a distance away from the light emitter. In some examples, the device may cause an irradiance of at least 0.01 mW/cm². The device may cause an irradiance of at least 0.05 mW/cm². The device may cause an irradiance of at least 0.1 mW/cm². The device may cause an irradiance of at least 1 mW/cm². The device may cause an average irradiance of 1 mW/cm². The device may cause an average irradiance of 0.1 mW/cm². The device may cause an average irradiance of 0.05 mW/cm². The device may cause an average irradiance on a surface of 0.01 mW/cm². A target irradiance may be at least, greater than, less than, equal to, or any number in between about 0.01 mW/cm² and 10 mW/cm². In some examples an average irradiance is targeted across at least a portion of a surface and not the entire surface. The average irradiance may comprise an average of multiple measurement points taken within a volumetric body of water. In some examples, irradiance measurements may range from 0 mW/cm² to 100 mW/cm². In some examples, the target average irradiance may be any value within the range of 0.02 mW/cm² to 2 mW/cm². In some examples the average irradiance may be any value within the range of 0.02 mW/cm² to 5 mW/cm².

In some examples, the device may emit a minimum amount of radiometric energy measured from at least, greater than, less than, equal to, or any number in between about 10 mW and 100 W. The device may emit a radiometric energy sufficient to cause an irradiance within a body of water a distance away. The radiometric energy may be sufficient enough to inactivate at least one microorganism's population and/or multiple microorganism populations. In some examples, the device may comprise multiple light emitters that emit a combined radiometric energy. The device may comprise multiple LEDs that emit a combined radiometric energy. In some examples, the device may emit a radiometric energy of at least 20 mW measured within the range of 380 to 420 nm. In some examples, the device may emit a minimum amount of radiometric energy measured from, at least, greater than, less than, equal to, or any number in between about 375 nm and 425 nm.

In some examples, a dosage measured in J/cm\hat{ }2 is targeted. A dosage may be used as a metric for determining an appropriate irradiance for microbial inactivation over a period of time. A target reduction in microorganism population(s) may be used (e.g., 1-Log₁₀ reduction, 2-Log₁₀ reduction, 99% reduction, or the like). In some examples a target dosage may be at least 20 J/cm\hat{ }2. A target dosage may be between 10 and 100 J/cm\hat{ }2. A target dosage may be more than 100 J/cm\hat{ }2.

In some examples, the device disclosed herein may use continuous disinfection. For example, an object or a surface intended to be disinfected may be continuously irradiated by one or more of the light emitter(s) disclosed herein. In some examples, an object or surface may be illuminated for a first percentage of time (e.g., 80% of the time) and not illuminated for a second percentage of time (e.g., 20% of the time), such as when the object or surface is being interacted with by a human, etc. In some examples, an integrated control system may determine that a minimum dosage over a certain period of time has been met for disinfecting purposes and disinfecting light may be turned off to save energy until the period of time expires and resets. In some examples, disinfecting light may be turned off 30% of the time over a specific time period, such as 24 hours, and may still be considered continuous (e.g., 16.8 hours out of 24). Other similar ratios may be possible.

In some examples, a photocatalyst may be used to enhance the disinfection. The photocatalyst may be coated on or embedded into a surface or within the device. The photocatalyst may be coated or embedded into a lens. The photocatalyst may be coated on or embedded into a light emitter.

In some examples, the light emitter(s) disclosed herein may use intermittent disinfection. Some examples use intermittent disinfecting techniques where the disinfecting light may be only irradiating an object or surface intended to be disinfected, e.g., a hot tub, for a certain period of time. In some examples, disinfecting light may shine on the object or surface intended to be disinfected for 8 hours overnight. In some examples, disinfecting light may shine on the object or surface intended to be disinfection for a period of time between 30 seconds and 8 hours. In some examples, the period of time the object or surface is exposed to the disinfecting light may match up with a specific time required to meet a certain dosage target for the inactivation of a specific microorganism.

As described herein, light used for disinfection may be continuous or intermittent. An object or a surface intended to be disinfected may be continuously illuminated. An object or surface may be illuminated with disinfecting light for a first fraction of time (e.g., 80% of the time) and not illuminated with disinfecting light for a second fraction of time (e.g., 20% of the time). An object or a surface may be illuminated by disinfecting light, for example, if the object or the surface is not being interacted with (e.g., not being used) by a user. An object or a surface may not be illuminated by disinfecting light, for example, if the object or the surface is being interacted with (e.g., being used) by a user. For example, disinfecting light may be deactivated if a user opens an appliance door (e.g., a washing machine), etc.

In some examples, one or more of the light sources disclosed herein may pulse disinfecting light. By pulsing the disinfecting light emitter(s) or otherwise reducing its duty cycle below 100%, the dose and exposure may be decreased, and the lifetime of the light emitter(s) may be increased. Pulsed light at high irradiances may be more effective than continuous light at lower irradiances. In some examples, pulsed light may have higher exposure limits compared to a continuous light source. In some examples, pulsed light may be considered to be intermittent because the light will be on and off periodically. In some examples, however, pulsed light may be used continuously and thus may also be considered continuous disinfection due to the length of time that light is pulsed (e.g., light may be pulsed for 24 hours straight).

In some examples, the light emitter(s) may emit light according to a proportion of spectral energy. The proportion of spectral energy may be an amount of spectral energy within a specified wavelength range, i.e., 380-420 nm, divided by a total amount of spectral energy of the light. In some examples, the proportion of spectral energy may be a percentage.

The light emitted from the light emitter(s) may comprise a proportion of a spectral energy of the light, measured in a 380 nanometers (nm) to 420 nm wavelength range, greater than 50%. The light may comprise a full width half max (FWHM) emission spectrum of less than 20 nm and centered at a wavelength of approximately 405 nm to concentrate the spectral energy of the light and minimize energy associated with wavelengths that bleed into an ultraviolet wavelength range. The light may provide an irradiance at the surface sufficient to initiate inactivation of microorganisms on the surface.

Different colors of light may be emitted with a percentage (e.g., 20%) of their spectral energy within the wavelength range of 380-420 nm or within a UV wavelength range. In some examples, various colors of light may be emitted with a percentage of 30% to 100% spectral power within the wavelength range of 380-420 nm. For example, a white light containing light across the visible light spectrum from 380-750 nm, may be used for disinfection purposes, with at least 20% of its energy within the wavelength range of 380-420 nm. In some examples the percentage of spectral energy within the wavelength range of 380-420 nm is at least 50%. In some examples the percentage of spectral energy within the wavelength range of 380-420 nm is at least 60%. In some examples the percentage of spectral energy within the wavelength range of 380-420 nm is at least 70%. In some examples the percentage of spectral energy within the wavelength range of 380-420 nm is at least 80%. In some examples the percentage of spectral energy within the wavelength range of 380-420 nm is at least 90%. In some examples the percentage of spectral energy within the wavelength range of 380-420 nm is at least 95%. In some examples the percentage of spectral energy within the wavelength range of 380-420 nm is at least 99%. In some examples the percentage of spectral energy within the wavelength range of 380-420 nm is at least 100%.

Light emitted from a light emitter may be white, may have a color rendering index (CRI) value of at least 70, may have a correlated color temperature (CCT) between approximately 2,500 K and 5,000 K, and/or may have 10% to 44% of spectral energy and/or spectral power in a 380 nm-420 nm wavelength range. Other colors of light (e.g., blue, green, red, and/or the like), with a portion of spectral energy and/or spectral power within a wavelength range of 380 nm-420 nm that is greater than a threshold (e.g., 20%), may also be used for disinfection.

In some examples, light emitted from light emitter(s) may be white, may have a color rendering index (CRI) value of at least 70, may have a correlated color temperature (CCT) between approximately 2,500K and 5,000K and/or may have a proportion of spectral energy measured in the 380 nm to 420 nm wavelength range between 10% and 44%. Other colors (e.g., blue, green, red, etc.) may also be used with a minimum percentage of spectral energy (e.g., 20%) within the range of 380-420 nm, which provides the disinfecting energy. In some examples, the white light may include a proportion of spectral energy measured in the 200 nm to 230 nm wavelength range between 0.01% and 2%.

Light emitter(s) may take any light emitter form capable of emitting light or energy e.g., light emitting diode (LED), LEDs with light-converting layer(s), laser, electroluminescent wires, electroluminescent sheets, flexible LEDs, organic light emitting diode (OLED), or a semiconductor die.

In some examples, the light emitters may be LEDs (light emitting diodes) emitting light with a peak wavelength, for example, at least, greater than, less than, equal to, or any number in between about 375 nm, 376 nm, 377 nm, 378 nm, 379 nm, 380 nm, 381 nm, 382 nm, 383 nm, 384 nm, 385 nm, 386 nm, 387 nm, 388 nm, 389 nm, 390 nm, 391 nm, 392 nm, 393 nm, 394 nm, 395 nm, 396 nm, 397 nm, 398 nm, 399 nm, 400 nm, 401 nm, 402 nm, 403 nm, 404 nm, 405 nm, 406 nm, 407 nm, 408 nm, 409 nm, 410 nm, 411 nm, 412 nm, 413 nm, 414 nm, 415 nm, 416 nm, 417 nm, 418 nm, 419 nm, 420 nm, 421 nm, 422 nm, 423 nm, 424 nm, and 425 nm.

In some examples, the light emitters emit at a beam angle of 130 degrees. In other examples, the light emitters emit at a beam angle of, for example, at least, greater than, less than, equal to, or any number in between about 90 degrees, 95 degrees, 100 degrees, 105 degrees, 110 degrees, 115 degrees, 120 degrees, 125 degrees, 130 degrees, 135 degrees, 140 degrees, 145 degrees, 150 degrees, 155 degrees, 160 degrees, 165 degrees, 170 degrees, 175 degrees, 180 degrees. If the gap is approximately 2 in, in some examples, then approximately 12 light emitters spaced approximately evenly in a grid pattern will provide illumination to the entire surface of an approximately 17 in×14 in fibrous media filter. This example is shown for reference only, other filter sizes, shapes, beam angles, light emitter quantities, and gap distances are possible.

In some examples, any lens material in the device may comprise an antistatic element to prevent the buildup of particles on it. In some examples the lens may comprise an antistatic coating to prevent the buildup of particles on it.

In some examples, the light emitter(s) may emit disinfecting light. The intensity of the disinfecting light from light emitter(s) may vary based on the angle the disinfecting light is emitted from the light emitter(s). In some examples, disinfecting lighting element may have a beam angle of up to 180 degrees. In some examples, the beam angle may be 60, 120, and/or 130 degrees. The intensity of the disinfecting light may be highest in the center of a beam of disinfecting light emitted from the light emitter(s). In some examples, the intensity may be lower towards the edge of the beam of disinfecting light than the center of the beam. In some examples, the intensity at the edge of a beam of disinfecting light may be 50% of the maximum intensity which may occur in the center of the beam. In some examples, the intensity of the disinfecting light may decrease further from the light emitter(s). The disinfecting light may, for example, have a maximum intensity close to the light emitter(s) and the intensity may decrease as the disinfecting light travels further from the light emitter(s). Due to this, the light emitter(s) may be placed such that there is sufficient light coverage on the target surface, i.e., filter. The spacing of the light emitter(s) is based upon the distance between the light emitter(s) and the target surface, the radiometric power output of the light emitter(s), and the beam angle of the light emitter. In some examples, the light emitter(s) create a circular light coverage area on the target surface. In some examples, the light emitter(s) will be positioned such that the contour line receiving 50% of the maximum intensity which may occur in the center of the beam on the target surface provided from one light emitter, overlaps with the contour line receiving 50% of the maximum intensity which may occur in the center of the beam on the target surface provided from a separate light emitter such that the areas on the target surface receiving less than 50% of the maximum intensity which may occur in the center of the beam is minimized. In some examples, the overlap between the emitters may be, for example, at least, greater than, less than, equal to, or any number in between about 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79% and 80% of the maximum intensity.

In some examples, a surface to be disinfected may be in close proximity to a light emitter. In such examples, a device may require more light emitters than would otherwise be necessary for disinfection. The area illuminated by a single light emitter may be limited by a beam angle of the light emitter. The same light emitter may illuminate a larger surface area of the surface to be disinfected if the light emitter is moved further away. Therefore, the device disclosed may need an increased number of light emitters to cover the entire surface area of the surface to be disinfected with disinfecting light, as compared to a further distance. Light emitters may be spaced a distance from the surface to be disinfected. The light emitters may emit a light that spreads outwardly toward the surface at a beam angle. The beam angle may comprise half of an angle of light emitted from the light emitter, in degrees, where the intensity of light is at least 50% of light emitter's maximum emission intensity. In some examples, the light emitter may comprise LEDs and the beam angle may be 130 degrees, e.g., the angle of light emitted from the light emitter where the intensity of light is at least 50% of the maximum emission intensity is 130 degrees. In some examples where light from the light emitter does not possess rational symmetry, the beam angle may be given for two planes at 90 degrees to each other.

In some examples, secondary optics may be used to increase the beam angle of the emitter. This can reduce the number of emitters needed when the target surface is in closer proximity to the light emitters. The secondary optics may transform the Lambertian point source radiation pattern to a batwing, angle bending, or side-emitting radiation pattern. The beam angle of the batwing radiation pattern may be 120-180 degrees. The angle bending radiation pattern may shift the primary beam angle of the emitter by 10-90 degrees off of center, The side emitting radiation pattern may direct a primary beam of light at an angle 120-180 degreed to one side of the emitter

A total surface area illuminated by one light emitter may be determined by the beam angle and the distance from the light emitter to the surface intended to be disinfected. A light emitter with a larger beam angle may provide a larger total surface area illuminated by one light emitter. An increased distance between the light emitter and the surface may also increase the total surface area illuminated by one light emitter. The total number of light emitters that may be needed to disinfect the entire surface to be disinfected may be based on the total surface area illuminated by one light emitter. As the distance from the surface intended to be disinfected to the light emitter decreases, the number of light emitters that may be needed to disinfect the surface may increase.

In some examples, a control system may be operatively coupled to the device or system it is utilized in. The example control system may be operative to control operational features of the device such as but not limited to: a duration of illumination, type of light emitter used, exiting light color, light intensity, and/or light irradiance. The control system may include any now known or later developed processor, microcontroller, system on a chip, computer, server, network device, mesh network device, internet-of-things device, mobile device, etc. The light device may also include at least one sensor coupled to control system to provide feedback to control system. In some examples, sensor(s) may sense any parameter of the control environment of the device, motion of a user, motion of structure to which device is coupled, motion of the device itself, temperature, humidity, light reception, position of panels covering the antimicrobial filter layer, opacity of the fibrous media filter, presence and/or level of volatile organic chemicals, air quality and/or air particulates and/or presence of microorganisms on exterior surface, combinations thereof, etc. Sensor(s) may include any now known or later developed sensing devices for the desired parameter(s). The control system with sensor(s) (and without) can control operation to be continuous or intermittent based on external stimulus, and depending on the application.

In some examples, the control system and/or lights may be wired or wirelessly coupled to the internet (with or without a gateway) and a cloud or on-premises server to control or record data associated with the control system and/or light emitters. In some examples, usage patterns and determinations regarding time-on in different modes, irradiance or dosage thresholds being met may be recorded.

Some microorganisms may respond differently to different wavelengths. In some examples, the control system may adjust the spectrum of the light based on the type of microorganism. For instance, some microorganisms may require high levels of 405 nm light, e.g., >1 mW/cm² for several hours. In some examples, the 405 nm light may be required, for example, at least, greater than, less than, equal to, or any number in between about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71 and 72 hours. The same microorganisms may only require 10 uW/cm² at 222 nm, for example, in a smaller time period (minutes) to achieve the same kill. Therefore, it may be beneficial to know the type of microorganism so that the spectrum can be tailored to it. In some examples, the control system may be pre-programed to target specific microorganisms. In some examples, data regarding dosage, irradiance, etc. for a specific microorganism may be input manually. In some examples, the control system or remote server may comprise a database containing optimal spectra for different types of microorganisms.

In some examples, a bioburden sensor may be used to detect the type of microorganism and transmit information to the control system for targeting the microorganism. In some examples, the bioburden sensor may be an autofluorescence sensor, which may comprise a light emitter to cause excitation of the bioburden, and a sensor to measure the resulting emission from the bioburden. This bioburden sensor may interact with the control system or remote database to cause tuning of the light's spectrum.

A computing device (e.g., a controller) may be comprised by the device disclosure and may perform the functions of various control systems described herein, and/or any other computer, controller, or processor-based function described herein. The computing device may implement, for example, a control system for control of various lighting parameters, as described herein. In some examples, the computing device, in communication with one or more sensors and one or more lighting devices may implement lighting controls based on sensor measurements. In some examples, the computing device may be a microcontroller configured to implement the functions of various control systems described herein.

The computing device may include one or more processors, which may execute instructions of a computer program to perform any of the features described herein. The instructions may be stored in any type of tangible computer-readable medium or memory, to configure the operation of the processor. As used herein, the term tangible computer-readable storage medium is expressly defined to include storage devices or storage discs and to exclude transmission media and propagating signals. For example, instructions may be stored in a read-only memory (ROM), random access memory (RAM), removable media, such as a Universal Serial Bus (USB) drive, compact disk (CD) or digital versatile disk (DVD), floppy disk drive, or any other desired electronic storage medium. Instructions may also be stored in an attached (or internal) hard drive. The computing device may include one or more input/output devices, such as one or more sensors, lighting devices, display, touch screen, keyboard, mouse, microphone, software user interface, etc. The computing device may include one or more device controllers such as a video processor, keyboard controller, etc. The computing device may also include one or more network interfaces, such as input/output circuits (such as a network card) to communicate with a network such as example network. The network interface may be a wired interface, wireless interface, or a combination thereof. The computing device may comprise one or more timers to measure time. One or more of the elements described above may be removed, rearranged, or supplemented without departing from the scope of the present disclosure.

Various methods, devices, and systems described herein may use a control system to implement various lighting controls in the device disclosed. The control system may be used to control/adjust various aspects of disinfecting light (e.g., dosage, radiant flux, color, time, wavelength, intensity, and/or irradiance). In various examples, the control system may be used to control similar parameters corresponding to other wavelengths of light as well. The other wavelengths of light may correspond to white light, ultraviolet (UV) light, and/or other wavelengths that are not configured for disinfection. In other examples, controls may be implemented to turn off the disinfecting light when an individual opens the device to change or check the various filter(s) or filter layer(s) disclosed herein.

The control system may comprise the use of sensors. The sensor(s) may comprise, for example, one or more of irradiance sensors, radiant intensity sensors, motion sensors, voice sensors, odor sensors, capacitive touch sensors, magnetic proximity sensors, light sensors, infrared sensors, cameras, ultrasonic sensors, weight sensors, limit switches, and/or any other sensors.

The control system may comprise a timer. The timer may, for example, measure how long disinfecting light has been emitted towards an object. In some examples, the timer may measure the length of time since an enclosure was opened/closed. In some examples, enclosures using a timer to turn off the disinfecting lighting when a dosage has been met may also contain indication lighting to make the user aware that the disinfection cycle is complete. In some examples the indication light may be provided by additional lighting elements emitting colors outside of the disinfecting wavelength range, such as green light within the range of 520 to 560 nanometers.

In some examples, a module capable of emitting ultraviolet light may be used as a subcomponent within a device. The module may comprise of one of more of the following: LED PCBA, emitter, emitter package, driver or ballast, control circuitry, safety sensors, lens, reflector, cover, or enclosure. An LED PCBA may be a printed circuit board with surface mount LEDs. The module may also include driving circuitry, for example, to regulate current and voltage going to the LEDs. An emitter may be a UV emission source that is not an LED. A safety sensor may be used to prevent accidental exposure to the UV light. The safety sensor may comprise of an occupancy sensor, a timer, a button, or a control signal from a remote sensor or control system. The module may be enclosed such that UV light does not leak out and is only emitted through the lens.

Light emitters producing ultraviolet or visible light may comprise, for example, an LED, an array of LEDs, a laser, an array of lasers, a vertical cavity surface emitting laser (VCSEL), or an array of VCSELs. Other light emitters that may be used may include, for example, any emitter capable of emitting ultraviolet light including LEDs, fluorescent lamps without phosphor coatings, xenon arc lamps, mercury vapor, short-wave UV lamps made with fused quartz, black lights (fluorescent lamp coated with UVA emitting phosphor), amalgam lamps, natural or filtered sunlight, incandescent lamps with coatings that absorb visible light, gas-discharge (argon, deuterium, xenon, mercury-xenon, metal-halide, arc lamps, planar microcavity microplasma), halogen lamps with fused quartz, solid-state lamps, excimer lamps (such as Krypton Chlorine), etc. In some examples, an LED emitter may comprise at least one semiconductor die and/or at least one semiconductor die packaged in combination with light converting materials. In some examples, the light emitter may be fitted with optical components that may alter the path of the light, (e.g., focus the light into a beam).

In some examples, the light emitter(s) may be populated onto a light module or substrate, i.e., circuit board module or printed circuit board. The light modules may vary in material, shape, size, thickness, flexibility, and otherwise be conformed to specific applications. Base material of the substrate may comprise a variety of materials such as, for example, aluminum, FR-4 (glass-reinforced epoxy laminate material), Teflon, polyimide, or copper.

In some examples, a light emitter or a light module may comprise a conformal coating. The conformal coating may comprise a polymeric film contoured to the light emitting subcomponent. The conformal coatings may provide ingress protection from, for example, condensation or other liquids.

In some examples a transparent or translucent surface, such as a lens, may be required as part of the device as a lens or protective material layer. The transparent or translucent surface may allow for 50%-100% transmission of the disinfecting wavelengths. In some examples the materials incident to the disinfecting wavelength selected for the device may have high reflectance of the disinfecting wavelengths in order to increase the intensity/irradiance. The materials may be, for example, matte or glossy white plastics, or materials with mirror like finishes. In some examples, the transparent or translucent surface may allow for 70%-100% relative transmission of the disinfecting wavelengths to the overall visible spectrum wavelengths. In some examples, the transparent or translucent surface may allow for 50%-100% transmission relative to air of the disinfecting wavelengths. In some examples, materials that exhibit fluorescence under disinfecting light are not used due to the reduction in efficacy from absorption of disinfecting wavelengths and emission of longer wavelengths potentially out of the disinfecting wavelength range. In some examples, additives are added to the material to reduce gradual transmission reduction over time due to exposure to high temperatures. Light transmission may be at least 75%.

In some examples, it may be desirable to dissipate heat generated by lighting elements or other components of a light emitter as disclosed herein. A decreased operating temperature may increase reliability and lifetime of a device. Heat may affect the peak wavelength and spectrum emitted by the light emitter(s). For example, as temperatures rise, peak wavelengths may shift to longer wavelengths. Similarly, as temperatures decrease, peak wavelengths may shift to shorter wavelengths. Therefore, it may be desirable to constrain the temperature to a certain range in order to maintain a desired peak wavelength or spectrum within some tolerance. In some examples, the light emitter or light module may be coupled to a heatsink. The heatsink may be made out of plastics, ceramics, or metals including, for example, aluminum, steel, or copper. The heatsink may also be made out of a plastic or ceramic material. In some examples the heatsink may be permanently coupled to a light emitter or light module, or otherwise considered a part of the assembly that makes up the light emitter or light module. In some examples the heatsink may be built into the structure the light module is mounted to, such as the frame of the antimicrobial filter layer.

The device disclosed herein may be powered through power outlets, electrical power supplies, batteries or rechargeable batteries mounted in proximity to the appliance, and/or wireless or inductive charging. Where rechargeable batteries are employed, they may be recharged, for example, using AC power or solar panels (not shown), where sufficient sunlight may be available. In some examples, AC power and an AC to DC converter, i.e. LED driver or power supply, may be utilized. In some examples, direct DC power may be utilized when available. In some example, the device will take in direct DC power from the device it is installed into, an air purifier for example.

In various examples described herein, light at a specified wavelength or wavelength range may correspond to light which has a maximum emitted energy/power/energy spectral density/power spectral density approximately at the specified wavelength or within the specified wavelength range, with reasonable variations (e.g., ±5 nm, ±10 nm, etc.).

The above discussed embodiments are simply examples, and modifications may be made as desired for different implementations. For example, steps and/or components may be subdivided, combined, rearranged, removed, and/or augmented; performed on a single device or a plurality of devices; performed in parallel, in series; or any combination thereof. Additional features may be added.

1. A method comprising:
detecting, via a sensor, a microbial characteristic of a body of water;
comparing the microbial characteristic to a target threshold;
wherein upon determining the microbial characteristic is below the target threshold the method further comprises:
emitting, via a light emitter in a device, a disinfecting light comprising a wavelength range of 380-420 nanometers (nm) into the body of water;
determining, via a controller, a concentration and frequency of chemicals to deposit into the body of water based on the detected microbial characteristic;
depositing, via a mechanism in a device, a chemical into the body of water at the determined concentration and frequency.

2. The method of claim 1, wherein the microbial characteristic is a level of a chemical in the body of water.

3. The method of claim 1, further comprising:
determining, via a controller, a radiometric output of disinfecting light to be emitted into the body of water before emitting, via the light emitter in the device, the determined radiometric output of disinfecting light into the body of water.

4. The method of claim 1, wherein the disinfecting light is emitted for a period of time before turning off.

5. The method of claim 1, further comprising:
displaying, via a graphical display, indicator light, or mobile application, a status of the disinfecting light or chemical deposition.

6. The method of claim 1, further comprising:
sensing, via a second sensor, a second characteristic of the body of water.

7. The method of claim 6, wherein the second characteristic may be one of: temperature, pH, oxidation-reduction potential, chemical level, alkalinity, stabilizers, cyanuric acid, irradiance, bioburden, motion, or calcium hardness.

8. The method of claim 4, wherein the period of time is calculated from a recommended dosage for a threshold percent kill required of microorganisms in the body of water and a measured irradiance.

9. The method of claim 1, wherein the determined concentration and frequency of chemicals decreases by a percentage as the output of the disinfecting light increases.

10. The method of claim 1, wherein emitting the disinfecting light comprising a wavelength range of 380-420 nanometers (nm) is emitted to only a portion of the body of water per a first method cycle, and wherein a sensor location may change before a second method cycle begins.

11. A method comprising:
emitting, via a light emitting in a device, a disinfecting light comprising a wavelength range of 380-420 nanometers (nm) into a body of water;
detecting a microbial characteristic of the body of water via a sensor;
comparing the microbial characteristic to a target threshold;
wherein upon determining the microbial characteristic is below the target threshold the method further comprises:
depositing, via a mechanisms in a device, a chemical into the body of water at a concentration and frequency.

12. The method of claim 11, wherein the microbial characteristic is an irradiance of light comprising a wavelength range of 380-420 nm measured within the body of water.

13. The method of claim 11, wherein the microbial characteristic is a level of a chemical in the body of water.

14. The method of claim 11, wherein the disinfecting light comprises a radiometric power of at least 10 mW.

15. The method of claim 11, wherein the disinfecting light emits continuously.

16. The method of claim 11, further comprising:
displaying, via a graphical display, indicator light, or mobile application, a status of the disinfecting light or chemical deposition.

17. The method of claim 11, further comprising:
sensing, via a second sensor, a second characteristic of the body of water.

18. The method of claim 17, wherein the second characteristic may be one of: a temperature, pH, oxidation-reduction potential, chemical level, alkalinity, stabilizers, cyanuric acid, irradiance, bioburden, motion, or calcium hardness.

19. The method of claim 18, further comprising:
displaying, via a graphical display or mobile application, the second characteristic of the body of water.

20. A device comprising:
a housing;
a sensor configured to measure a microbial characteristic of the water;
a light emitter disposed within the housing below a surface of a body of water and configured to emit light within a wavelength range of 380-420 nanometers (nm) into the body of water;
a mechanism disposed within the housing and below the surface of the body of water and configured to deposit chemicals at a concentration and frequency into the body of water.
